(19) United States
(12) Patent Application Publication
(10) Pub. No.: US 2005/0034064 A1
(43) Pub. Date: Feb. 10, 2005

(54) Method and system for creating and following drill links

(75) Inventors: Aaron Stephen Meyers, Provo, UT (US); Robert Alan Meyers, Orem, UT (US); Eric Stephen Meyers, Provo, UT (US)

Correspondence Address: Robert B. Hicks, 1162 N. 1050 E., Orem, UT, 84097, US

(73) Assignee: ActiveViews, Inc., Provo, UT (US)

(21) Appl. No.: 10/765,232

(22) Filed: Jan. 26, 2004

Related U.S. Application Data
(63) Continuation-in-part of application No. 10/627,180, filed on Jul. 25, 2003.

(51) Int. Cl. G06F 17/00

(52) U.S. Cl. 715/513

(57) ABSTRACT

A method and system for creating and following drill links in a report are disclosed. A relational abstraction of a data store is defined, the definition including a plurality of views, scalar or aggregate fields associated with the views, and relations between the views. A report is generated that includes at least one drill link associated with a sequence of one or more relations originating at a base view of the relational abstraction. Upon selecting a drill link contained in a first report, information about the drill link is extracted from the report, and the extracted information and the destination view associated with the drill link are used to create a second report.

### CROSS REFERENCE TO RELATED APPLICATION

This application is a continuation-in-part of co-pending U.S. patent application Ser. No. 10/627,180 filed on Jul. 25, 2003 entitled “Method and System for Building a Report for Execution against a Data Store.” This prior application is incorporated herein by reference.

### BACKGROUND OF THE INVENTION

The present invention relates to information processing and more particularly to database access and reporting systems and methods related to information processing.

Data access and reporting have long played an essential role in enterprise management. Without the ability to adequately access, summarize, and manipulate raw data the efficiency of an enterprise suffers. Typically reporting systems perform specific data access and reporting functions designed to provide enterprises meaningful access to data.

However, many reporting systems lack the functionality to provide users with the ability to look behind the data contained in a report. Others have limited functionality to permit users to drill down into data provided in a report. For example, some reporting systems allow a user to see that a global sales number is comprised of national sales numbers, which are comprised of regional sales numbers, which are comprised of city sales numbers. Still other reporting systems allow users to drill through data in a report in a limited manner. For example, a reporting system may allow a user looking at customer data to drill through into orders placed by that customer and see all of the orders placed by the customer.

However, reporting systems that provide the ability to drill down or drill through data typically rely on static links predefined by a person familiar with the data. Thus, such reporting systems lack the ability to allow a user to see data behind data provided in a report for which a predefined drill link has not been defined. Some reporting systems attempt to overcome this limitation by creating super reports, reports that include predefined links for a large number of data items. Notwithstanding, these super reports are limited by the access needs perceived by the report designers and further can overwhelm users with too much data, making them unhelpful.

Additionally, because super reports and reports that include predefined drill links require extensive knowledge of underlying data structures, they are often prohibitively expensive to create, maintain and deploy. With prices in the hundreds or thousands of dollars per copy, and tens of thousands of dollars for an enterprise license, data access and reporting may be prohibitively expensive. This is especially true in the case of a small or start-up business.

Thus, there is a general need in the art for a data access method and system that frees report designers from the necessity of building predefined drill links in reports and from developing super reports that are overwhelming and confusing to users. There is also a general need for reports that include dynamically generated drill links based upon an entity relationship of data. There is also a need for a data access method and system that is inexpensive and affordable by individuals or small companies.

### SUMMARY OF THE INVENTION

According to the present invention, a method and system for creating and following drill links in a report are provided. The method and system empower information technology professionals and report designers to efficiently and inexpensively provide reports that novice or casual computer users can use to easily follow relations inherent in data and see how data is related to other data.

According to one embodiment, the present invention is implemented through a distributed application that runs on multiple computers but is displayed on a graphical user interface (GUI). This GUI, combined with common input devices such as a mouse and keyboard, minimizes the learning curve for use of the present invention. Thus, even a novice or casual user may quickly and easily understand and apply the present invention to access and build reports from a data store.

The embodiment provides a simple-to-use application that displays fields associated with a data store. The fields associated with a data store are defined in a relational abstraction of the data store. The embodiment provides an easily comprehended means of interactively and iteratively selecting fields defined in the relational abstraction, according to the user's desires in response to simple and efficient input commands. Using the invention, a user selects an initial view associated with the relational abstraction. This view, referred to herein as the base view, becomes the entry point into the relational abstraction and is used to constrain which fields are displayed for selection by the user and which relations of the relational abstraction can be followed to select the fields. Selecting the base view is inherently understandable by users because the base view comprises the answer to what the user selects as the basis for a report.

Based upon the base view and an embodiment of the invention, a user may select fields associated with any view of the relational abstraction, and may follow relations within the relational abstraction to select additional fields. As the user follows relations within the relational abstraction, the fields displayed are constrained by the base view and the relation path from the base view. Users thus have fields displayed for selection that are appropriate to answer the question associated with the base view. As the user selects fields, a report is generated which includes the selected fields and drill links associated with the fields.

The present invention defines a data store in terms of a relational abstraction. The relational abstraction generally parallels the entity-relationship inherent in a well designed transactional relational database. Doing so preserves the business logic associated with such transactional systems for use by users of the invention. However, one skilled in the art will readily recognize that an entity-relationship abstraction may also be applied to data storage systems that are not in the genre of traditional relational database management systems and do not have a traditional entity relationship structure.

In an embodiment of the invention, the relational abstraction is maintained in one or more extensible Markup Language (XML) files which comprise metadata which describes a data store. The relational abstraction includes views associated with the data store, scalar or aggregate fields associated with views and relations between views. View definitions identify tabular structures of rows and columns in the data store. Field definitions describe columns of data accessible in a particular view. Relation definitions describe associations between various views. Typically such definitions are associated with one or more tables and columns of a conventional relational database management system. However, one skilled in the art will recognize that any means of providing an entity-relationship view on data may be used as part of the invention and more than one data store may be represented in the relational abstraction.

A powerful benefit of the present invention comes from automatically and dynamically generating drills links within reports. As users build reports using the invention by selecting fields or following relations of the relational abstraction, the system maintains a relation path of all objects relative to a base view. The relation path maintains not only the relation of the objects to the base view but also the sequence of relations followed by the user relative to the base view. Only those fields that are logically available based upon the base view selected by the user and the relation path sequence followed by the user from the base view are available to include in a report. If a relation path sequence contains only to-one relations, scalar fields can be included. If a relation path sequence contains a to-many relation, aggregate fields can be included. If a relation path sequence contains a to-many relation followed by a one-to-one relation, distinct aggregates can be included.

Based upon the cardinality constraints imposed by the base view, the relation path, including the relation path sequence, and the relational abstraction, the embodiment determines if selected objects can be included in reports as drill links. Selected scalar fields whose relational abstraction definitions explicitly indicate that they can be included as drill links are automatically included as drill links. Selected aggregate fields are included as drill links because they inherently aggregate data. In an embodiment of the invention, even objects that are not explicitly defined in the relational abstraction as drillable links, can be defined by a user to be included as drill links in a report.

According to the invention, drill links can be included in reports of various formats. Such report formats may include well known formats such as HyperText Markup Language (HTML), Dynamic HyperText Markup Language (DHTML), eXtensible Markup Language (XML), Portable Document Format (PDF) and Scalable Vector Graphics (SVG). One skilled in the art will recognize that any report format that provides a facility to describe hyperlinks may be used by the invention.

According to the invention, a drill link may include information that provides additional powerful benefits to report designers and users. A drill link may include a reference to a second report. A drill link may include a reference to a web page that includes a second report. A drill link may include a reference to an object not associated with the relational abstraction, such as a web page, a graphic generation program or communications program. A drill link may include a reference to information about the report containing the link, including the location of the report, the location or context of the drill link within the report, or key values associated with other data contained in the report.

Another benefit of the invention comes from associating a drill link with another object of the relational abstraction and using the destination view associated with the last sequence in the relation path as a base view for a new report. The object associated with the drill link might be any object of the relational abstraction, including a scalar field, an aggregate field, an expression or a template. The template might include references to other objects in the relational abstraction. A destination view is a view derived by following a relation from a base view to another view within the relational abstraction. Another powerful benefit of the invention derives from using the extracted information to apply a filter or restrict the data returned in the second report. If the drill link includes information about a scalar field in the first report, the second report might return only data of the second report containing the contents of the scalar field of the first report. According to the invention, many pieces of information may be included in the drill link and used to apply filters or restrict data returned in the second report.

That the invention improves over the drawbacks of prior database access and report applications and accomplishes the advantages described above will become apparent from the following detailed description of preferred embodiments and the appended drawings and claims.

### BRIEF DESCRIPTION OF THE DRAWINGS

Other features and advantages of the present invention will be apparent from the following Detailed Description taken in conjunction with the accompanying Drawings, in which:

FIG. 1 is a block diagram of a distributing computing system that provides an exemplary operating environment for the present invention.

FIG. 2 is a tabular diagram of a sample database used to describe certain embodiments of the invention.

FIG. 3A is a tabular diagram of certain metadata objects associated with the sample database depicted in FIG. 2.

FIG. 3B is a tabular diagram of certain metadata objects associated with the sample database depicted in FIG. 2.

FIG. 3C is a tabular diagram of certain metadata objects associated with the sample database depicted in FIG. 2.

FIG. 3D is a tabular diagram of certain metadata properties associated with an embodiment of the present invention.

FIG. 3E is a series of tables illustrating eXtensible Markup Language (XML) examples of metadata objects associated with an embodiment of the present invention.

FIG. 4 is a main display window of an embodiment of the present invention.

FIG. 5 is a window display illustrating a software wizard used in an embodiment of the present invention.

FIG. 6A is a window display illustrating selection of a database according to an embodiment of the present invention.

FIG. 6B is a window display illustrating selection of a base view according to an embodiment of the present invention.

FIG. 7 is a window display illustrating various screen elements of the present invention, including a detail field drop area according to an embodiment of the present invention.

FIG. 8 is a window display illustrating a group field drop area according to an embodiment of the present invention.

FIG. 9 is a window display illustrating a measure field drop area according to an embodiment of the present invention.

FIG. 10A is a logic flow diagram illustrating the display of fields and relations associated with a data store according to an embodiment of the present invention.

FIG. 10B is a logic flow diagram illustrating the display and selection of fields for inclusion in reports according to an embodiment of the present invention.

FIG. 11 is a logic flow diagram illustrating the steps of operation of defining a relational abstraction, and including and following drill links in reports according to the invention.

FIG. 12 is a window display illustrating a report created by an embodiment of the invention which report includes drill links.

FIG. 13 is a window display illustrating a report created by an embodiment of the invention by following one of the drill links of FIG. 12.

FIG. 14 is a window display illustrating the fields included in a default drill template associated a report.

FIG. 15 includes two window displays illustrating how a user might make a field drillable according to an embodiment of the invention.

### DETAILED DESCRIPTION

The present invention may be embodied in a computer database access and reporting system that displays selected database data based upon base views, and the fields and relations associated with those base views and generates reports using selected fields. Selected database data is displayed on a display surface according to row, column, summary and group criteria chosen by a user. The display surface is typically an active window on a display device of a simple application program, but the display surface may alternately be a window of a web browser or any application program operable for displaying and manipulating data. The display surface is typically a monitor, but may alternately be a printer, flatscreen LCD display, television, and so on.

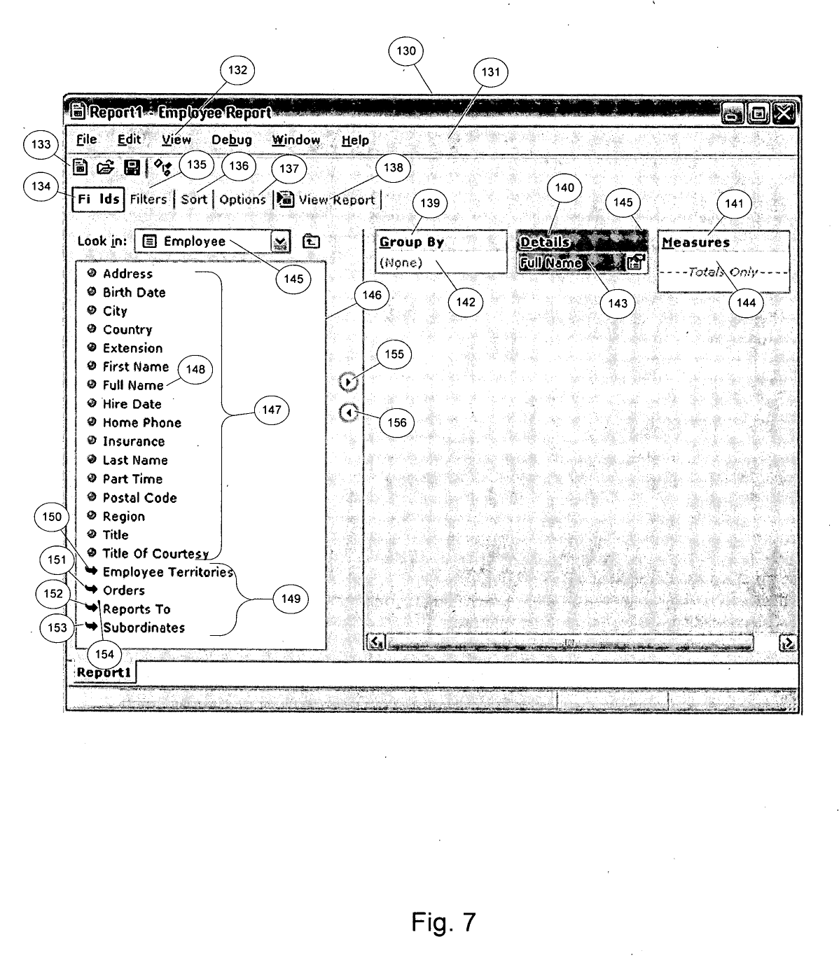

In one embodiment of the invention, a computer application includes a Query Construction Window 130 as depicted in FIG. 7. Referring to FIG. 7, the Query Construction Window 130 includes a Recursive Tree Structure 146, a Column Drop Area 143, a Group Drop Area 142 and a Measures Drop Area 144. The Recursive Tree Structure 146 is a display item used to display database views and associated fields and relations. According to one embodiment of the present invention, the Recursive Tree Structure 146 is displayed at the left of the Query Construction Window 130 and is column-shaped. The Group Drop Area 142 is a display item used for adding fields from the Recursive Tree Structure 146 to create row groupings of a report, is typically located to the right of the Recursive Tree Structure 146, and is column-shaped. The Column Drop Area 143 is a display item used for adding fields from the Recursive Tree Structure 146 to create columns of a report, is typically located to the right of the Group Drop Area 142, and is column-shaped. The Measures Drop Area 144 is a display item used for adding fields from the Recursive Tree Structure 146 to create summary or total fields of a report, is typically located to the right of the Column Drop Area 143, and is column-shaped. Alternate embodiments may use different means of displaying and selecting the names of database fields and relations.

Alternative embodiments may also use more drop areas, or a single drop area, or any other means of displaying fields and relations. Alternate embodiments may also change the shape of the drop area display items to fit various displays; for example, the drop areas may be round, square, triangular, or a custom shape as needed, or may be located in a pull-down menu or in some other type of user interface configuration. For example, the drop areas may be located in combined windows on the display screen, or may be represented by icons or buttons rather than blank fields.

A user may also add columns to a report by selecting fields. Referring to FIG. 7, to add columns, a user selects a Column Drop Area Heading 140, which selection identifies to the system that the user desires to add columns to a report, whereupon the system displays a list of fields in the Recursive Tree Structure 146 that corresponds to the base view of the associated relational abstraction. The user then adds fields to the Column Drop Area 142 by initiating a drag-and-drop command or by double-clicking the desired field, or by clicking an Arrow-Transfer-Button 155. The system captures this action by adding the field to the list of columns and by displaying the selected field name in the Column Drop Area 143.

A user may also add row groupings to a report. To add row groupings, a user selects a group field from the list of fields in the Recursive Tree Structure 146 and drops the field in the Group Drop Area 142 by initiating a drag-and-drop command, or, provided the Group Drop Area 142 is active, by double-clicking the desired field, or by clicking the Arrow-Transfer-Button 156. The system captures this action by adding the field to the list of row groupings and by displaying the selected field name in the Group Drop Area 142.

A user may also add numeric summary or aggregation measures to a report. To add measures, a user selects an aggregation or measures field from the list of fields in the Recursive Tree Structure 146 and drops the field in the measures drop area by initiating a drag-and-drop command, or, provided the measures drop area is active, by double-clicking the desired field, or by clicking the Arrow-Transfer-Button 156. The system captures this action by adding the field to the list of measures and by displaying the selected field name in the Measures Drop Area 144.

Likewise, a user may add fields from related database views to a report. Typically, the Recursive Tree Structure 146 will include a list of relations defined in the relational abstraction. To add fields from a related view, a user initiates a double-click command on a relation. The system will respond by replacing the previously existing list of fields and relations in the Recursive Tree Structure 146 with a new list based upon the selected relation and the cardinality existing between the base view and the destination view of the relation. The user may then add fields from the Recursive Tree Structure 146 to the Column Group Area 143, Group Drop Area 142 or Measures Drop Area 144, as noted above.

As a user select the desired fields to be grouped and displayed in a report, a system implementing the invention determines if the fields should be included in the report as drill links. If a definition of a selected field in the relational abstraction flags the field as drillable, a drill link is included in the report definition. If the field is an aggregate field, a drill link is included in the report definition.

Once a user has selected the desired fields to be grouped and displayed in a report, the user may choose to view a corresponding report. In the present invention, the list of fields and relations displayed for selection by a user is based upon a base view. Typically, the system will retrieve a list of tables and views from a database server and display them on a display surface. A user may then select one of the tables or views. Based upon the user's selection, the system will display a relational abstraction of all tables, views, fields and relations of the selected database table using the base view as a starting point.

In an embodiment of the invention, when a drill link in a report containing drill links is selected, the drill request is handled by loading the report definition from which the link originated, determining the destination view of the drill link that was selected, creating a new report based upon a template for the destination view, constructing a filter for the new report that incorporates the grouping keys or the primary filter of the first or originating report and displaying the second report.

As used herein, a “user” refers not only to a person using the present invention, but also to a program, application, operating system, function call, or any other entity that may make use of the present invention. Thus, an operating system that manipulates or otherwise employs the present invention is classified as a user.

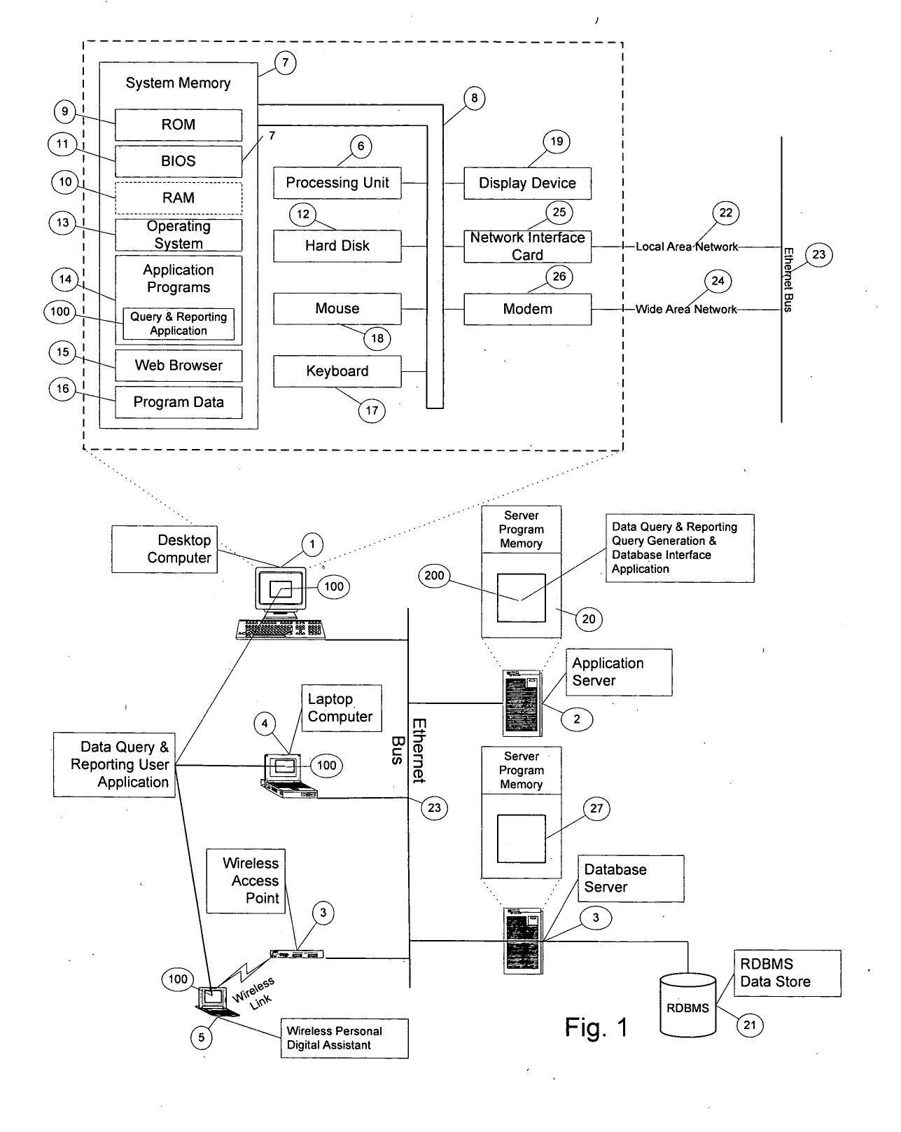

FIG. 1 and the following discussion are intended to provide a brief, general description of a suitable computing environment in which the invention may be implemented. While the invention will be described in the general context of application programs running on operating systems in a distributed computing environment where tasks are linked through a communications network, those skilled in the art will recognize that the invention also may be implemented in varying types of computer environments, including desktop computers, laptops, hand-held devices, multiprocessor systems, microprocessor-based or programmable consumer electronics, minicomputers, mainframe computers, and the like. In a distributed computing environment, application programs may be located in both local and remote memory storage devices.

With reference to FIG. 1, according to one embodiment of the present invention, a computer system for implementing the invention includes a conventional Desktop Computer 1, an Application Server 2 and a Database Server 3. Typically, the Desktop Computer 1, the Application Server 2 and the Database Server 3 will operate in a networked environment using logical connections. Although FIG. 1 depicts a system including a Desktop Computer 1, it will be appreciated by those skilled in the art that other types of computing devices such as a Laptop Computer 4, or a Personal Digital Assistant 5, may also be used.

Typically, the Desktop Computer 1 includes a Processing Unit 6, System Memory 7, and a System Bus 8 that couples the System Memory 7 to the Processing Unit 6. The System Memory 7 includes Read Only Memory (ROM) 9 and Random Access Memory (RAM) 10, and a Basic Input/Output System (BIOS) 11 that contains the basic routines that help to transfer information between elements within the Desktop Computer 1, such as during start-up, and the ROM 9. The Desktop Computer 1 further typically includes a Hard Disk Drive 12. The Hard Disk Drive 12 is connected to the System Bus 8. The Hard Disk Drive 12 and its associated computer-readable media provide nonvolatile storage for the Desktop Computer 1. Although the description of computer-readable media above refers to a hard disk, it will be appreciated by those skilled in the art that other types of storage devices and media that are readable by a computer, such as a removable magnetic disk, a CD-ROM disk, a magnetic cassette, a flash memory card, a digital video disk, Bernoulli cartridge, and the like, may also be used included in, or attached to, the Desktop Computer 1.

A number of program modules may be stored in the Hard Disk Drive 12 and the RAM 10, including an Operating System 13, one or more Application Programs 14, a Web Browser Program 15, and Program Data 16. These program modules include a Data Query And Reporting User Application (DQR Application) 100 configured for implementing an embodiment of the present invention. A user may enter commands and information into the Desktop Computer 1 through conventional input devices such as a Keyboard 17 or a pointing device such as a Mouse 18. Other input devices (not shown) may include a pen, touch-operated device, microphone, joystick, game pad, satellite dish, scanner, or the like. A Display Device 19, such as a display screen, is also connected to the System Bus 8 via an interface. In addition to the Display Device 19, desktop computers typically include other peripheral output devices (not shown), such as speakers, scanners or printers.

Application Server 2 and a Database Server 3 may be personal computers, minicomputers or mainframe computers, or another common application platform, and may also include many or all of the elements described relative to the Desktop Computer 1. Typically, the logical connections depicted in FIG. 1 include a Local Area Network (LAN) 22 running over an Ethernet Network Bus 23 or a Wide Area Network (WAN) 24. Such networking environments are commonplace in offices, enterprise-wide computer networks, intranets and the Internet. Typically, Database Server 3 stores and manages data by means of a special set of files or folders, such as an RDBMS Data Store 21 and makes that data available to other computer programs through Application Programming Interface 27, which runs in Server Program Memory 28 of Database Server 3.

When used in a typical networking environment, the Desktop Computer 1 is connected to the LAN 22 through a Network Interface Card 25. When used in a WAN networking environment, the Desktop Computer 1 typically includes a Modem 26 or other means for establishing communications over the WAN 24, such as the Internet. The Modem 26, which may be internal or external, is connected to the System Bus 8. In a networked environment, Application Programs 20, or portions thereof, may be executed on Application Server 3 and stored in the server memory and storage devices. These application programs include a Data Query And Reporting Query Generation And Database Interface Application (Query Engine) 200 configured for implementing an embodiment of the present invention. Typically, the Query Engine 200 also includes an intermediate mapping or metadata layer that is used when communicating with a database server. It will be appreciated that the network connections shown are exemplary and other means of establishing a communications link between the computers may be used.

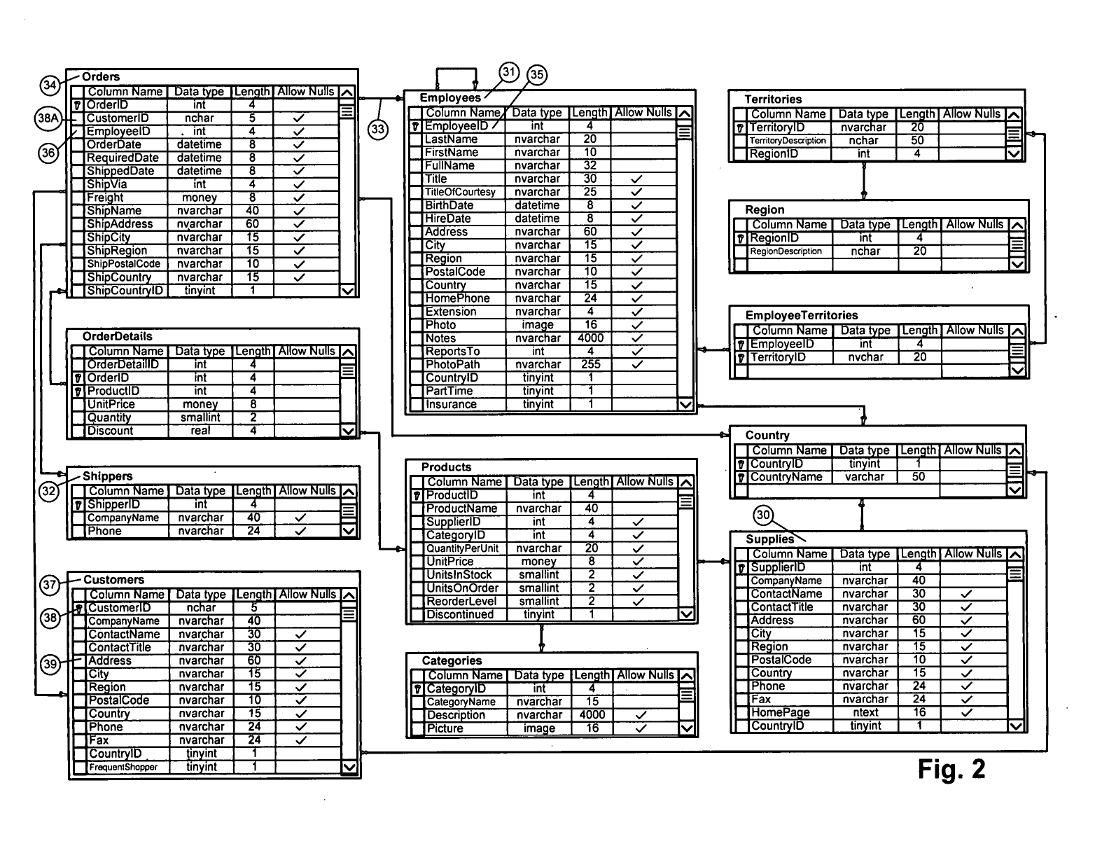

FIG. 2 is a block diagram illustrating the main tables, fields and the relations of a sample database, which has been derived from the Northwind database provided by Microsoft Corporation with its database server products. This modified Northwind database is used extensively in the embodiments illustrated below to show how the various embodiments of the DQR Application 100 and Query Engine 200 interact with a Data Store 21. Tables in the database are depicted in the large blocks of FIG. 2, such as a Suppliers Table 30, an Employees Table 31 and a Shippers Table 32. FIG. 2 also depicts connector lines between the tables to designate relations, such as a Relation 33 between the Employees Table 31 and the Orders Table 34. As depicted in FIG. 2, the key symbol and the infinity symbol (∞) designate the cardinality of relationships, thus the key symbol designates a “one-to” or a “to-one” relationship, and the infinity symbol designates a “many-to” or “to-many” relationship. Thus, the cardinality of the Relation 33 is expressed as one-to-many from the perspective of the Employees Table 31 in FIG. 2. As also shown in FIG. 2, the Relation 33 is linked between the EmployeeID Field 35 in the Employees Table 31 and the Employee ID Field 36 in the Orders Table 34.

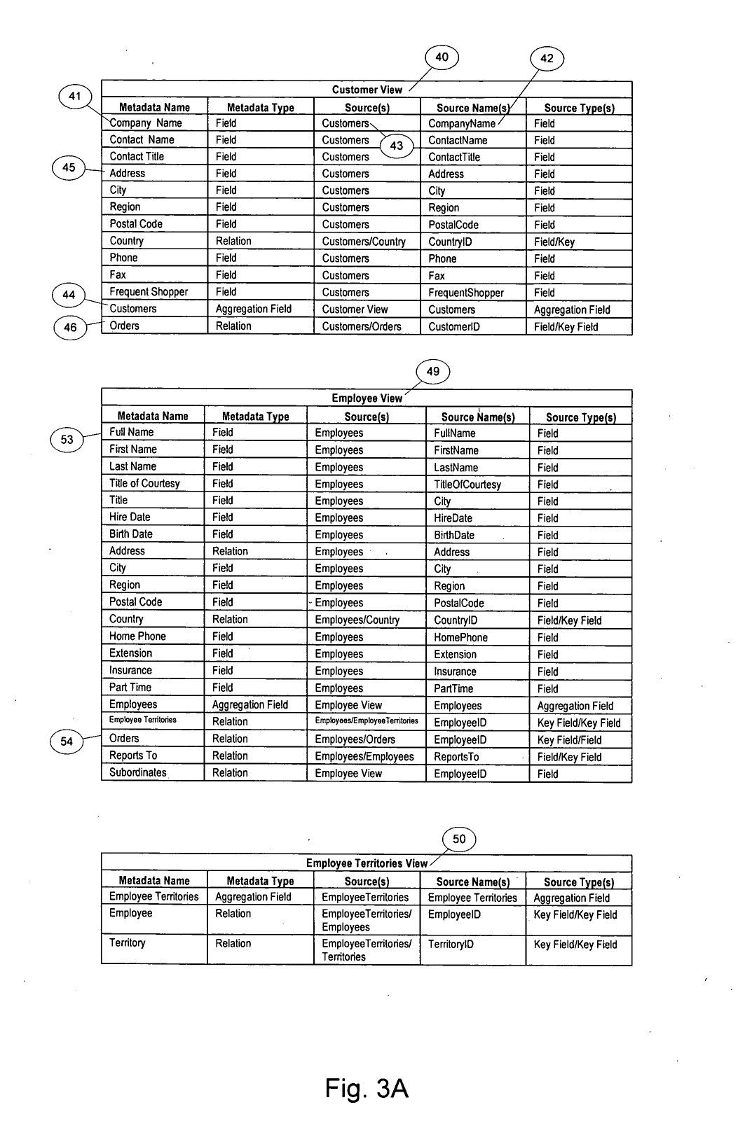

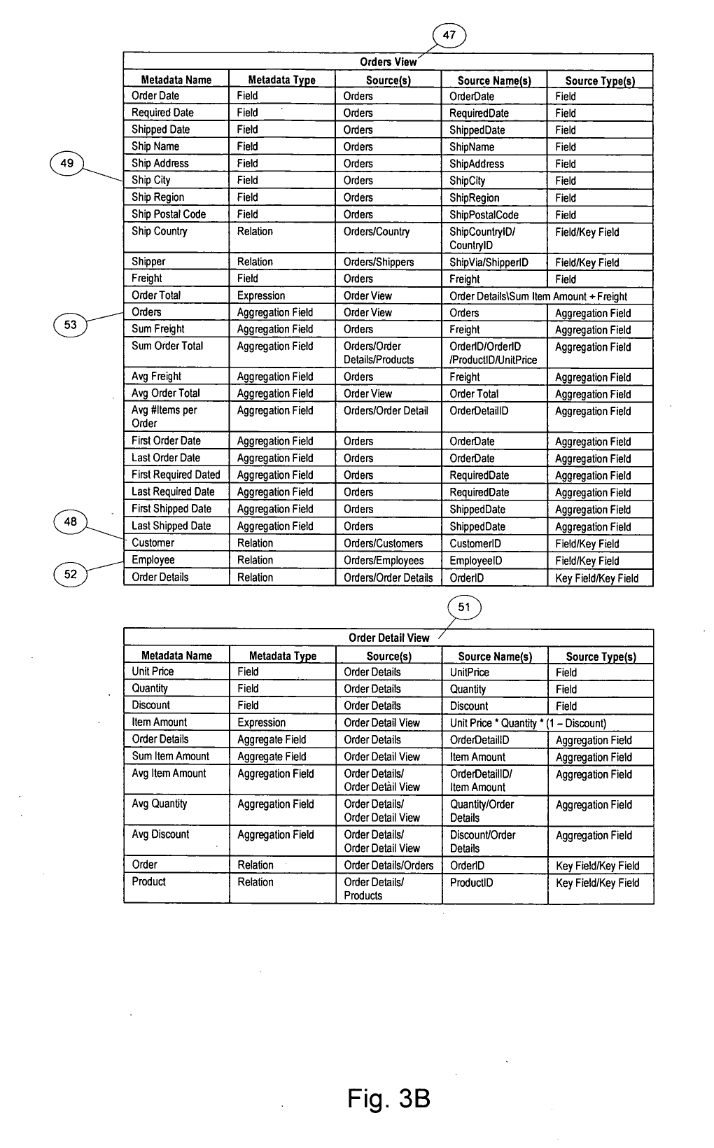

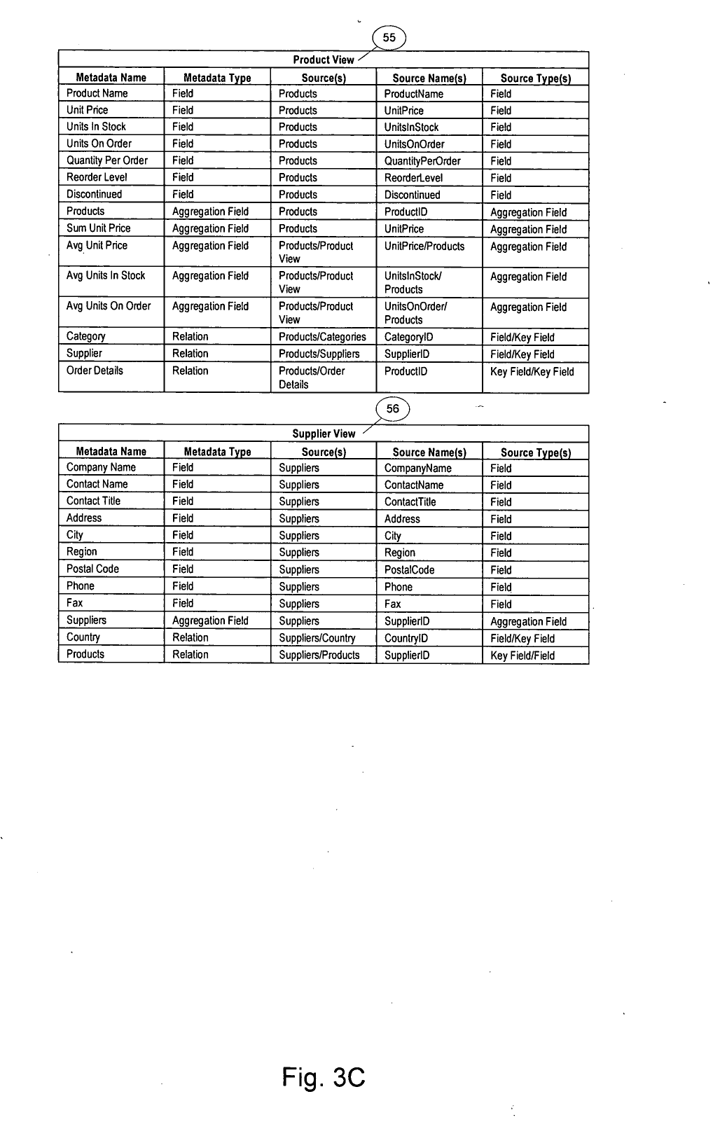

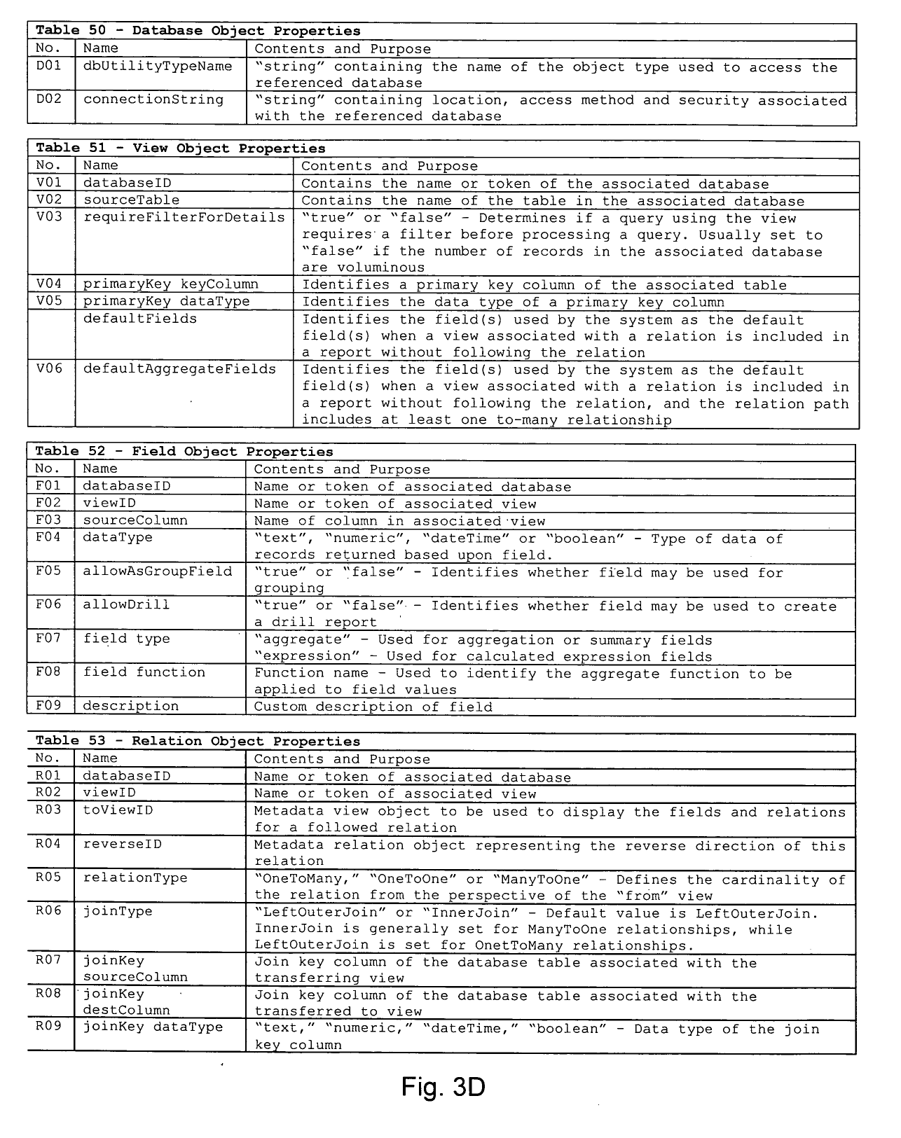

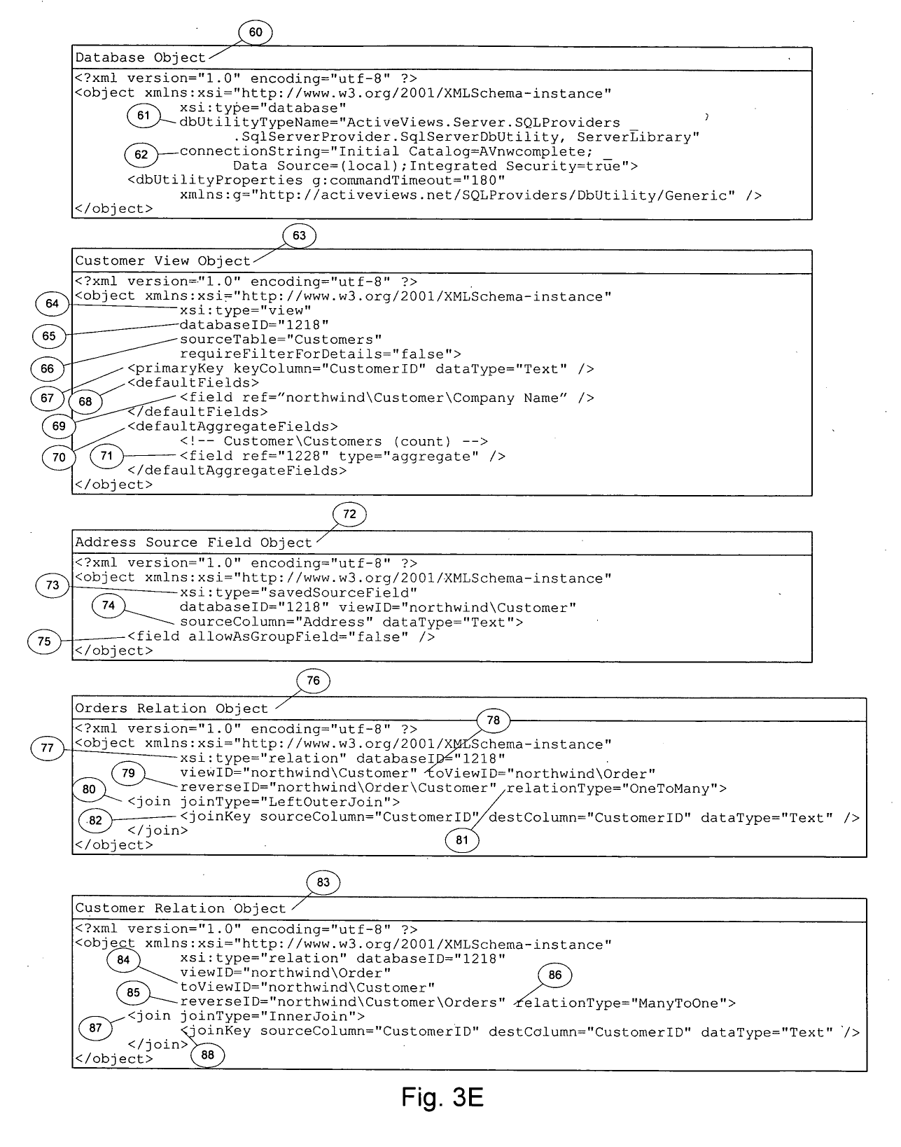

FIG. 3A, FIG. 3B and FIG. 3C are tables illustrating the mappings between the sample Northwind database tables, columns and relations and the views, fields and relations of an embodiment of DQR Application 100 and Query Engine 200, as used in one embodiment of the present invention. Such mappings are known by those skilled in the art as metadata, or data describing other data. Typically, such metadata mappings are constructed by personnel familiar with a data store and the data contained therein.

In the present example metadata, a “Customer View” Table 40 depicts a mapping between the sample Northwind database described in FIG. 2 and the DQR Application 100. Referring to Customer View Table 40 in FIG. 3A, a Company Name Field 41 is mapped to a CompanyName Field 42 in the Customers Table 37 of FIG. 2. Such is denoted by Balloon Number 43 in FIG. 3A. One skilled in the art will readily recognize the mappings between the metadata denoted in FIG. 3A, FIG. 3B and FIG. 3C and the tables, columns and relations of FIG. 2.

FIGS. 3D and 3E further disclose the organizational structure of the metadata associated with the foregoing example. In the present invention, metadata for a database is organized in a specific manner to facilitate use thereof. In one embodiment of the present invention, metadata is organized through at least four specific software objects. Such objects have methods and properties associated with them. Table 50 of FIG. 3D describes properties associated with database objects. For example, an Object Property dbUtilityTypeName D01 references a string containing the name of the object type used to access the referenced database, which could be a name readily understandable by humans or an alphanumeric reference to the database. An Object Property connectionString D02 references a string containing the location, access method and security associated with a database. Relevant to drill links, the Object Property allowDrill F06 identifies if a field can be included as a drill link. One skilled in the art will recognize that other property names and property types could readily be substituted for those presented in FIG. 3D. Further, one skilled in the art will also recognized that other software conventions such as functions, structures and the like could be used instead of objects.

According to one embodiment of the present invention, instances of the objects described in FIG. 3D are implemented through use of eXtensible Markup Language 1.0 (XML). Table 60 of FIG. 3E includes an XML description of an instance of the Database object described in the Table 50 for the Northwind sample database described in FIG. 2. Referring to FIG. 3E, note that a dbUtilityTypeName Property 61 specifies that SQL Server is the access method for the Northwind database. Note also that a connectionString Property 62 indicates the Northwind database is located on the local machine and accessed through integrated security. One skilled in the art will readily recognize that different database access service providers and securities interfaces may be used.

As shown in FIG. 3E, a Table 63 includes the XML description of an instance according to the description of the Table 51 of the Customer View 40. In one embodiment of the present invention, each view described by the metadata has a corresponding XML object definition. In the Table 63, the xsi:type=“view” Tag 64 specifies the object as a view object; the databaseID=“1218” Tag 65 specifies a shorthand notation referencing the modified Northwind database; and the sourceTable=“Customers” Tag 66 indicates that the Customer View is mapped to the Customers Table 37 in FIG. 2. The <primaryKey keyColumn=“CustomerID” dataType=“Text”/> Tag 67 indicates that the key field for the Customer View 40 is the CustomerID Field 38. The <defaultFields> Tag 68 enumerates the source fields displayed when the user fails to specify a field after following a relation that terminates on the Customer View 40. In the present case, the XML Tag<field ref=“northwind\Customer\Company Name”/> 69 references the Company Name Source Field 41 of FIG. 3A. The XML Tag<defaultAggregateFields> 70 enumerates the source fields containing numeric values associated with the Customer View 40, which are available for providing numeric summaries of data contained in a report. In the present embodiment, the XML Tag<field ref=“1228” type=“aggregate”/> 71 references the Customers Aggregation Field 44 of FIG. 3A.

Table 72 of FIG. 3E provides an XML description of the Address Field 45 of the Customer View 40 of FIG. 3A and the Customer View XML Object 63 in FIG. 3E. In one embodiment of the invention, each source field to be exposed for a view is similarly defined. The xsi:type=“savedSourceField” XML Tag 73 identifies an Address Object 72 as a data or source field. The sourceColumn=“Address” XML Tag 74 identifies the Address Field 39 as the data source for the Address Object 72.

As shown in FIG. 3E, an Orders relation Object Table 76 is an instance of a Relation object conforming to the Table 53, which provides an XML description of the Orders Relation 46 of FIG. 3A. According to one embodiment of the invention, each relation is similarly defined. Referring to the Orders Relation Object Table 76 of FIG. 3E, an xsi:type=“relation” Tag 77 defines the object as a relation object. The relation definition also includes a ViewID=“northwind\Order” Property 78, which in the present embodiment indicates that following a relation from the Customer View 40 to the Order View 47 will expose the fields and relations associated with the Order View 47. A reverseID=“northwind\Order\Customer” Property 79 indicates, should the Orders Relation 46 be followed, that the path back to the Customer View 40 will occur through use of the Customer Relation 48. A relationType=“OneToMany” Property 81 indicates that the relation from the Customer View 40 to the Order View 47 is one-to-many. The join type and the join keys for the Orders relation Object Table 76 are specified by a joinType=“LeftOuterJoin” property 80 and the <joinKey sourceColumn=“CustomerID” destColumn=“CustomerID” dataType=“Text”/> XML Tag 82, respectively. In this case, because the relationship is identified as a one-to-many relation, the join is specified as a left outer join. A left outer join of the Customer View 40 and the Order View 47 will include all records from the Customers Table 37 and the corresponding records in the Orders Table 34 where the CustomerID 38 and the CustomerID 38A are equal.

A Table 83 of FIG. 3E includes an XML description of the Customer Relation 48 of the Order View 47 of FIG. 3B. The Table 83 represents the reverse path associated with the Orders Relation 46. In this case, a toViewID=“northwind\Customer” Property 84 points to the Customer View 63, a reverseID=“northwind\Customer\Orders” Property 85 points to the Orders Relation Object Table 76, a relationType=“ManyToOne” Property 86 indicates that the relation is many-to-one, and a joinType=“InnerJoin” Property 77 indicates that the join is an inner join. An inner join will include records from both the Orders Table 34 and the Customers Table 37 where the values of the join keys specified by the <joinKey sourceColumn=“CustomerID” destColumn=“CustomerID” dataType=“Text”/> XML Tag 88 are equal.

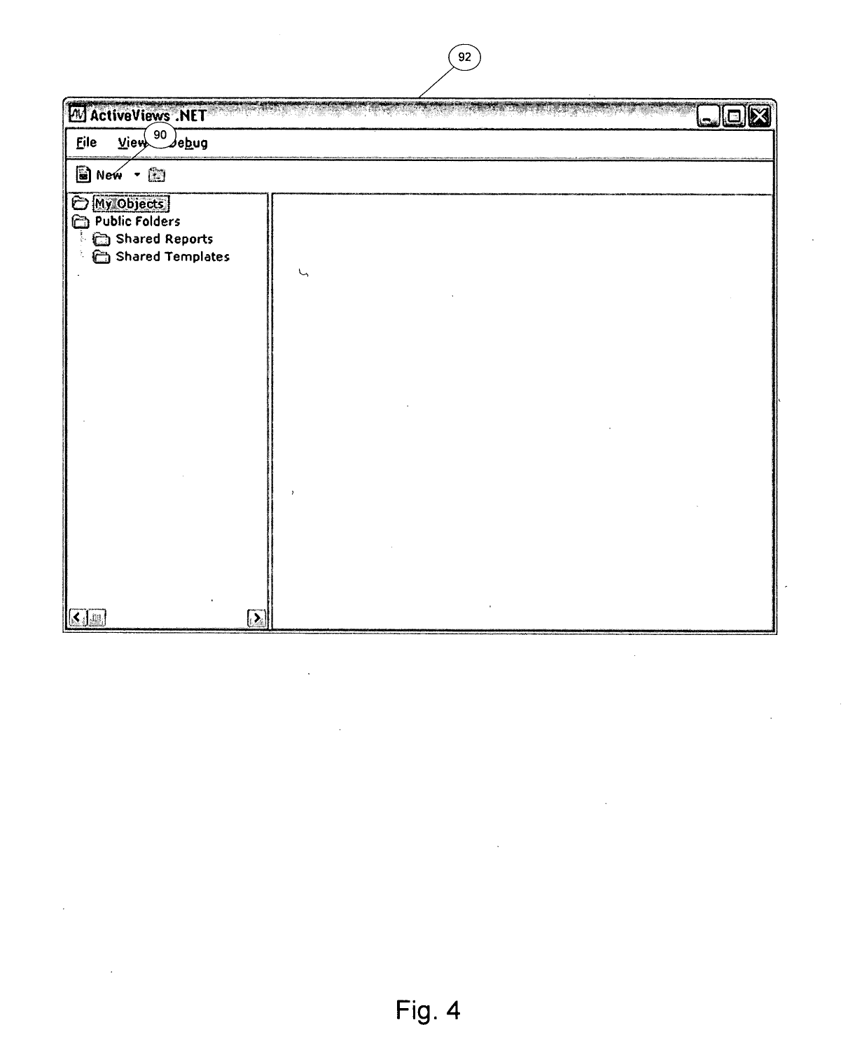

The present invention provides means to interactively and iteratively display fields for selection. FIG. 4 depicts a main or initial display Window 92 of an embodiment of the DQR Application 100. From this Window 92, a user of the DQR Application 100 may select a New Button 90 to create a new report.

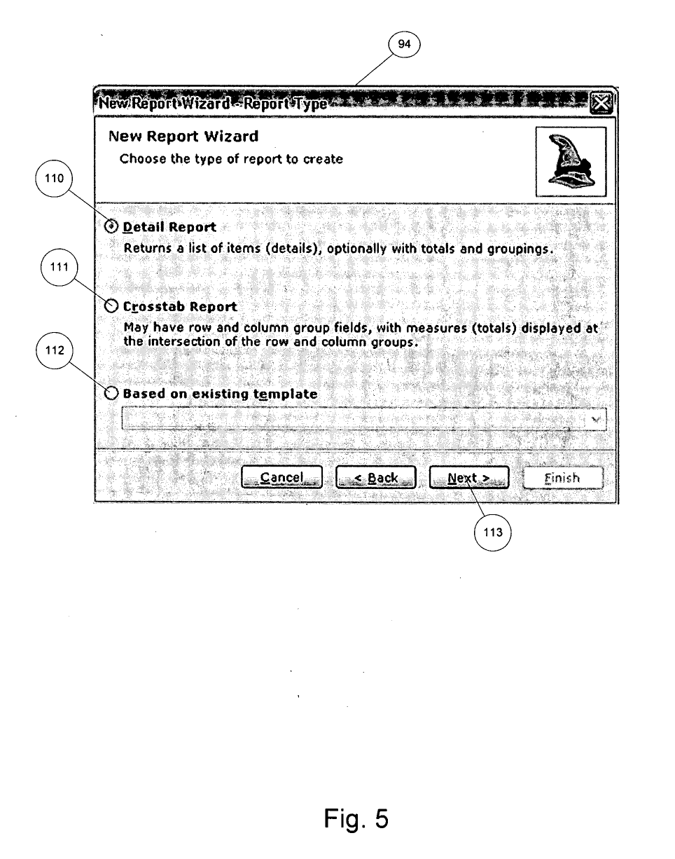

FIG. 5 depicts the Display Window 94 according to one embodiment of the DQR Application 100 that is useful for guiding a user through the process of selecting fields for a report. One skilled in the art will appreciate that various other interfaces may be used to facilitate creation of a report, including a menu-drive interface, a programmatic interface, a verbal interface, etc. In the embodiment shown, a user may select a Detail Report Radio Button 110 to create a new detail report. A detail report in the depicted embodiment is a list based upon one or more source fields of a database view. In this embodiment, a user may also select a Crosstab Report Radio Button 111 to create a tabulated report based upon the intersection of two source fields that bear a many-to-many relationship to each other. A user may also select a Based Upon Existing Template Radio Button 112 to create a report based upon a previously saved report or template. Once a user has selected a report type, a user may select a Next Button 113 to proceed to the next step in creating a report. A user may also select a Cancel Button 114 to stop building a report, or may select a Back Button 115 to return to the Window 92.

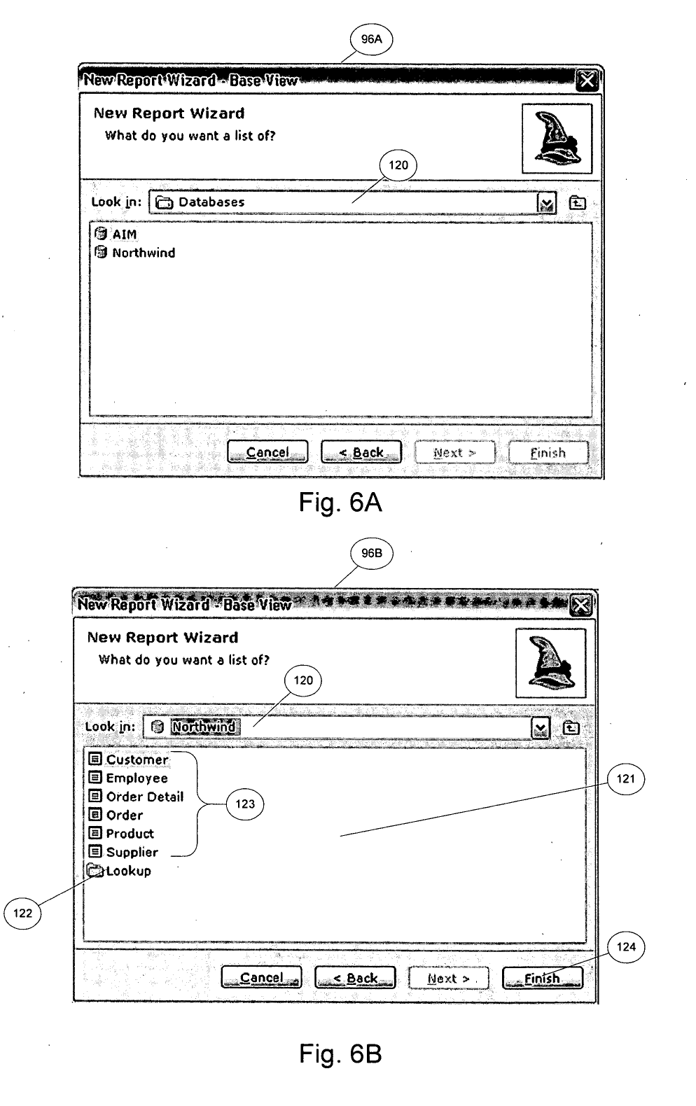

FIGS. 6A and 6B depict display Windows 96A and 96B, respectively, of an embodiment of the DQR Application 100 that allows a user to select a database view as the base view for use in a list type report. The user may select a database known to the DQR Application 100 and the Query Engine 200, as described by metadata associated with the database (an example of which is provided in FIGS. 3A-3E) by selecting one of the databases included in a Look In Drop Down Box 120. In the depicted embodiment, once a user has selected a database, the views associated with the database as described by the metadata are displayed in a View List 121 of FIG. 6B. In the present example, the views described in FIGS. 3A-3C appear in the View List 121.

In the depicted embodiment, views may be organized into subfolders, such as a Lookup Folder 122. This facility is provided for databases having a large number of defined views. In the depicted embodiment of the present invention, the base view is set by selecting a view from a List 123 and either selecting a Finish Button 124 or double-clicking on the selected view. This base view, in conjunction with the associated metadata described in FIGS. 3A-3C, as exposed by the Query Engine 200 and the DQR Application 100, is used in the invention to display fields associated with a relational abstraction of the database relative to the selected base view.

A relational abstraction of the present invention may be exposed through a display system and according to rules of the invention enforcing proper display and element selection. FIG. 7 depicts the Display Window 130 of the display system according to one embodiment of the DQR Application 100. Those skilled in the art will recognize that the Window 130 is a conventional window of a modern desktop application. However, those skilled in the art will also recognize that other conventional and non-conventional display means, screens and windows could be used. In the depicted embodiment, a Menu Bar 131 contains several menu items, including a View Menu Item 132, which in one embodiment of the invention shows the iterative nature of queries generated. A Toolbar 133 contains a Filters Button 135, a Sort Button 136, an Options Button 137 and a View Report Button 138. The Toolbar 133 and related buttons are used in this embodiment of the invention to display certain windows, fields and relations.

A Group By Box 139, a Details Box 140 and a Measures Box 141 are standard label boxes. The boxes below the Group By, Details and Measures areas of the display window, numbered respectively 130, 131 and 132, are drop box areas where a user may drag or locate fields when building queries. Note that in the depicted embodiment, a Details Drop Box Area 143 has been selected by default, as denoted by the darker gray colored background surrounding the Details Label 140. With such selection, a user may select from a Selection Area 146 one or more fields from a Field Group 147 that pertains to the Employee View 49, which is the view based upon the Employees Table 31 of the FIG. 2, as shown in a Look In Drop Down Box 145 of FIG. 7. In the depicted embodiment and present example, one of the scalar fields associated with the Employee View 49 is a Full Name Source Field 148, which has been selected according to the present invention as shown in the Details Drop Area 143. In the present example, a user may also follow relations between the Employee View 49 and the other views described in FIGS. 3A-3C, including an Employee Territories Relation 150, an Orders Relation 151, a Reports To Relation 152 and a Subordinates Relation 153. In the present example, the Reports To Relation 152 is visually designated as a to-one relation, as denoted by a superscripted “1” 154.

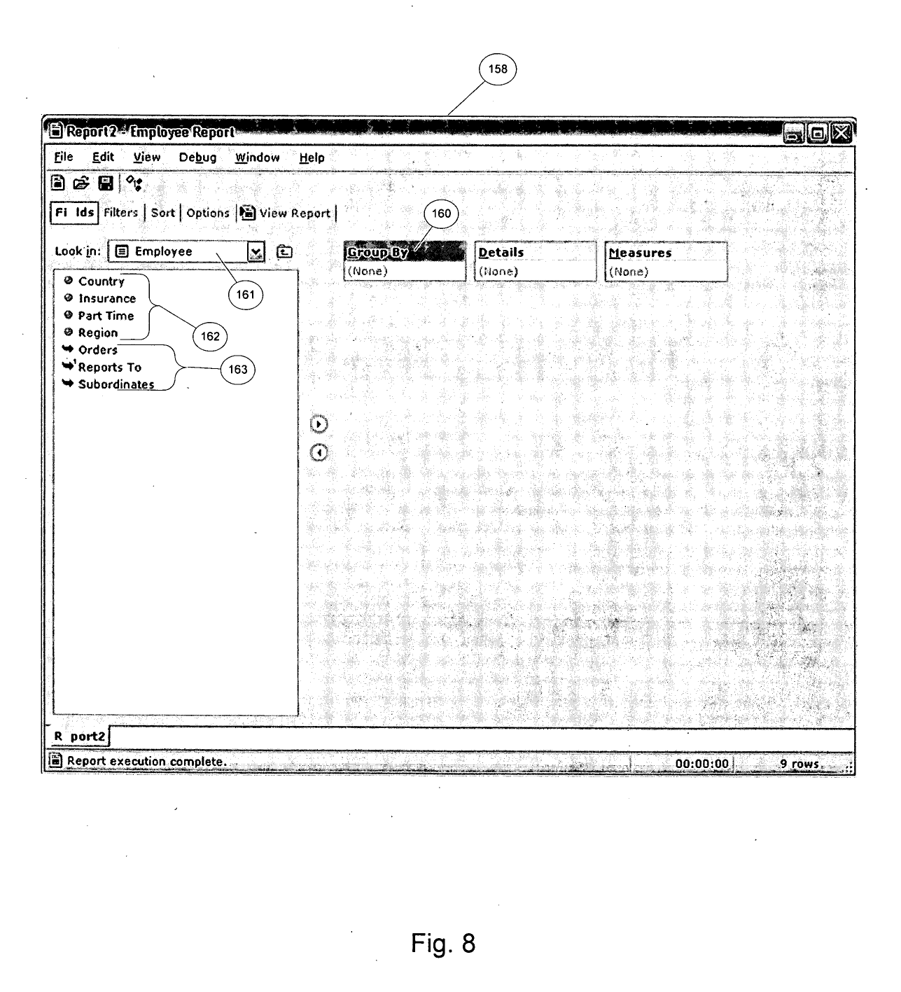

FIG. 8 depicts the Display Window 158 of an embodiment of the DQR Application 100 that illustrates selection of a Group By Drop Area 160. When the Group By Drop Area 160 is selected, the DQR Application 100 displays only those fields of the Employee View 49 as are designated in a Look In Drop Down Box 161 that can be used for grouping. Each such field will have been designated previously as a field available for grouping by setting an allowAsGroupField Property F05 (see FIG. 3D) in the metadata object associated with the filed to true. In the present example, the fields highlighted by a Balloon 162 may be selected and the relations highlighted by a Balloon 163 may be followed.

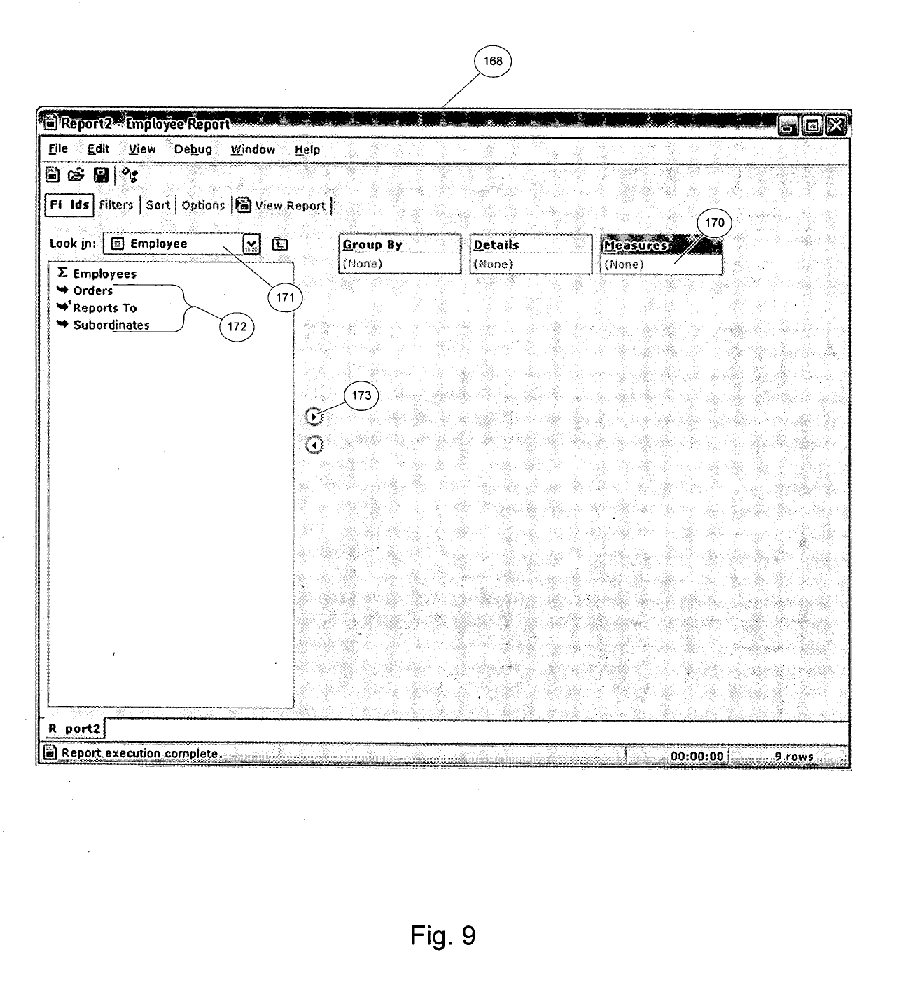

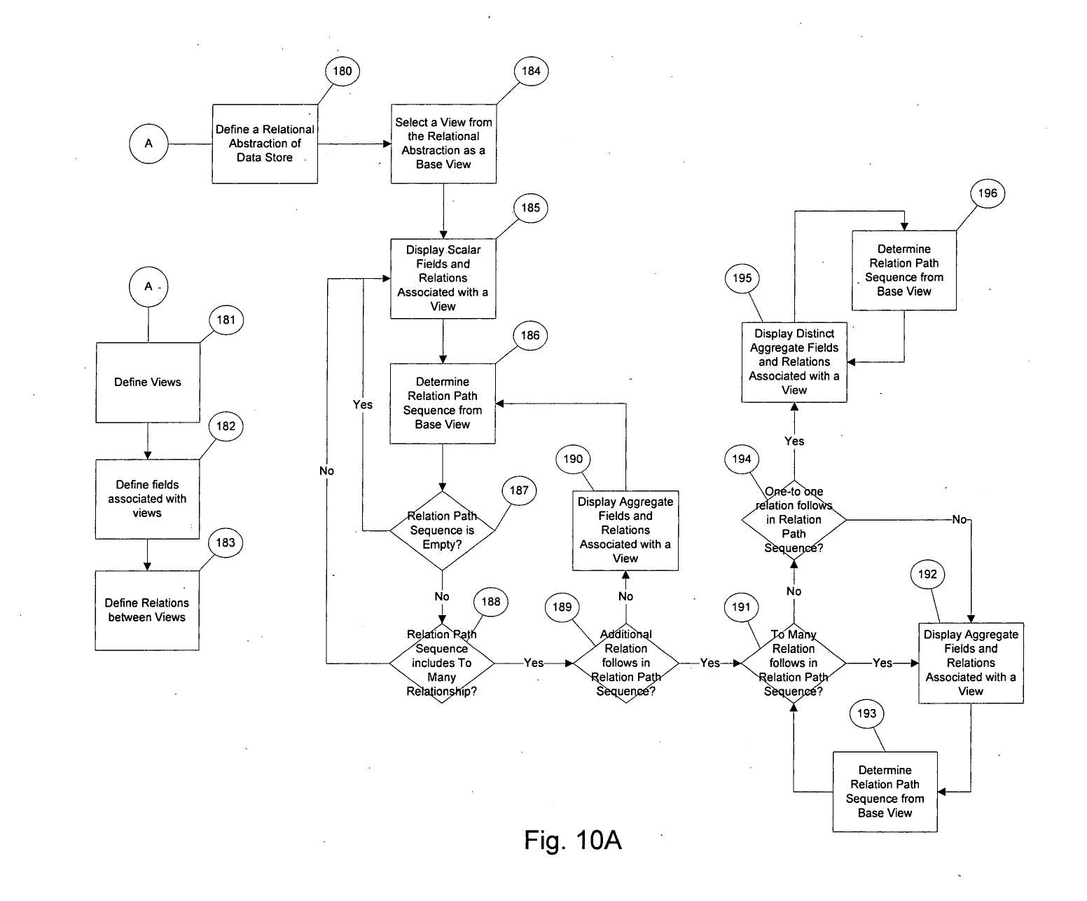

FIG. 9 depicts the Display Window 186 of an embodiment of the DQR Application 100 illustrating selection of a Measures Drop Area 170. In the depicted embodiment, the Measures Drop Area 170 provides a means to incorporate numeric summaries or totals into a report. When the Measures Drop Box 170 is selected, only those fields pertaining to the selected view, in the present example the Employee View 49, as designated in a Look in Drop Box 171, are available for selection. In the present example, the total number of employees in the Northwind database of FIG. 2 can be added to the Measures Drop Box 170. A user may also choose to follow one of the relations identified by a Balloon 172. In the present embodiment, a user chooses to follow a relation by double-clicking on the relation name. Should a user drag a relation name to the Measures Drop Area 170 or left-click on a relation name followed by clicking an Add Button 173 while the Measures Drop Area 170 is the default drop area, the DQR Application 100 will add the fields identified by a defaultAggregateFields Property V06 (See FIG. 3D) for the view to the Measures Drop Area 170.

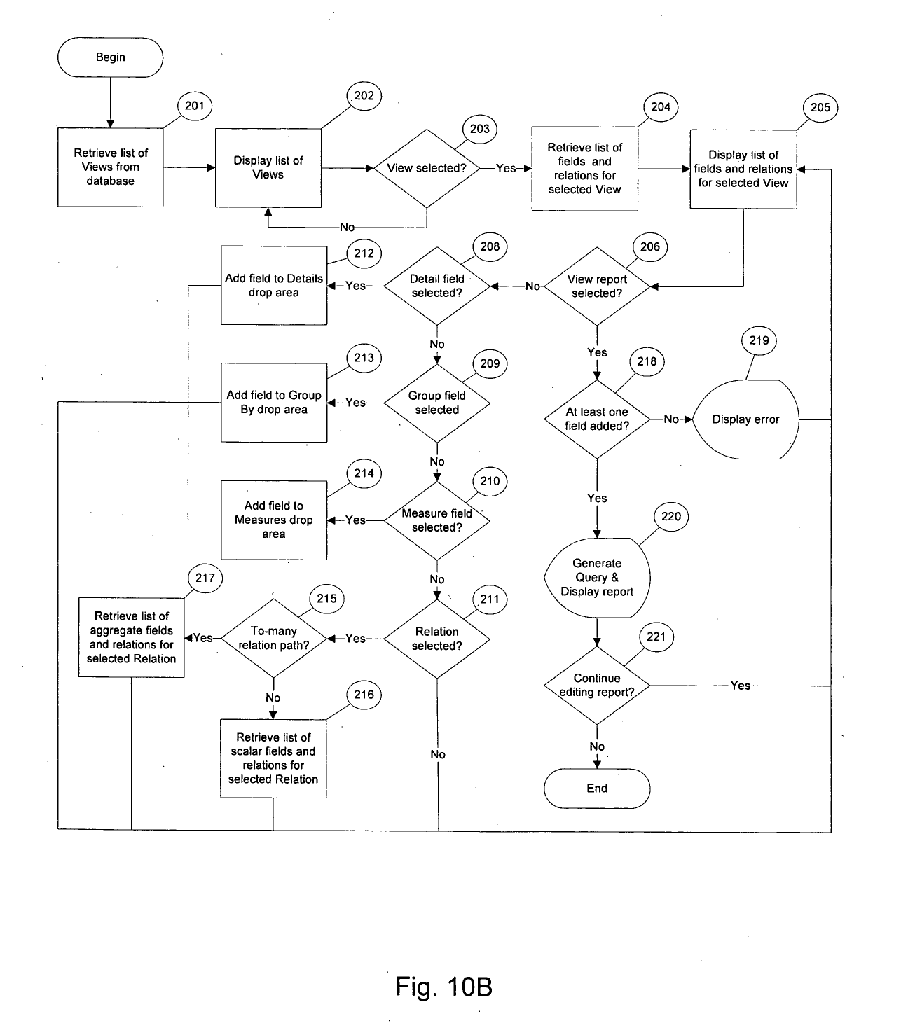

FIG. 10A displays a flowchart detailing the steps of operation of displaying fields. In step 180, a relational abstraction of a data store is created. Steps 181, 182 and 183 describe the steps of creating the relational abstraction. In Step 181, views of the data to be available for access from the data store are created. In Step 182, fields to be associated with such views are defined. In Step 183, relations between views are defined. In one embodiment of the present invention, a metadata layer that references a database, such as the Northwind sample database, is created, as depicted in FIGS. 3A through 3E and as described above. One skilled in the art will readily recognize that a similar abstraction may be created for data stores of all types, including data stores that are not based upon relational database methodologies.

Once a relational abstraction of a data store has been created, fields may be displayed for selection. In Step 184, a view is selected as the base view of a report. In step 185, scalar fields and relations of a view are displayed. In step 186, the relation path of the view is analyzed and a relation path sequence is extracted. According to step 187, if the relation path is empty, the scalar fields and relations associated with the base view are displayed. If the relation path is not empty, processing continues to step 188, where it is determined if the relation path sequence contains a to-many relationship. According to step 188, if the relation path sequence does not contain a to-many relationship, the scalar fields and relations associated with the destination view are displayed. Also according to step 188, if the relation path contains a to-many relationship, processing proceeds to step 189.

In step 189, the system determines if another relationship follows the to-many relationship of step 188 in the relation path sequence. If another relationship does not follow the to-many relationship in the relation path sequence, aggregate fields and relations associated with the destination view are displayed according to step 190 and processing returns to step 186. If another relationship follows the to-many relationship of step 188, processing proceeds to step 191 where a determination is made about what type of relation follows.

In step 191, if a to-many relation follows a to-many relation according to step 188, processing proceeds to step 192 where the aggregate fields and relations associated with the destination view are displayed. According to step 192, processing proceeds recursively to step 193 where the relation path sequence is again determined and processing returns back to step 191. If in step 191 a to-one relation follows a to-many relation according to step 188, processing proceeds to step 194. According to step 194, if the relation path sequence includes a to-many relation followed by a one-to-one relationship, distinct aggregate fields and relations associated with the destination view are displayed according to step 195 and all additional relation path sequence additions will display distinct aggregate fields.

If in step 194 the relation path sequence does not include a to-many relation followed by a one-to-one relation, the aggregate fields and relations associated with the destination view are displayed according to step 192 and processing proceeds recursively for each addition to the relation path.

FIG. 10B displays a flowchart that details the steps of operation for displaying and grouping fields according to an embodiment of the invention. In Step 201 an embodiment of the DQR Application 100 running on the Desktop Computer 1 requests a list of available databases and the list of metadata views identified in FIGS. 3A, 3B and 3C, from the Query Engine 200 running on the Application Server 2. The Query Engine 200 responds with the names of available databases and views, including the Northwind example database described in FIG. 2, and displays them through the Window 96A shown in FIG. 6.

In step 202, the DQR Application 100 displays the name of the Northwind database described in FIG. 2 and a list of the other available databases in the Look In Drop Down Box 120 on the Display Device 19. Step 202 also displays the metadata views described in FIGS. 3A, 3B and 3C in the View List Box 121 through the Window 96B shown in FIG. 6A.

In Step 203, a user sequentially selects the Employee View 49 from the View Group List 123 and the Finish Button 124, which causes the YES branch of Step 203 to be followed. If a user does not select a view, the NO branch of Step 203 is followed and the DQR Application 100 continues to display the Window 96B of FIG. 6A.

In Step 204, the DQR Application 100 requests the fields and relations listed in the Employee View 49 from the Query Engine 200. In Step 205, the DQR Application 100 then displays the list of fields and relations of the Employee View 49 on the Display Device 19, displaying the Window 130 described in FIG. 7.

In Step 206, the DQR Application 100 awaits user input in the form of selecting fields, such as those highlighted by the Balloon 147, or relations, such as those highlighted by Balloon 149, in FIG. 7. If the View Report Button 138 is selected, the YES branch of step 206 is followed to Step 218. If no fields have been added, the NO branch of Step 218 is followed to Step 219, an error is displayed directing the user to select at least one field, and the DQR Application 100 continues to display the list of fields and relations of the selected view, such as the Employee View 49. If the user selects a field or relation, the DQR Application 100 proceeds to Step 208.

In Step 208, the DQR Application 100 monitors detail field selections. If a user does not select a detail field, the DQR Application 100 continues through the NO branch to Step 209. If a user selects a detail field, the DQR Application 100 proceeds through the YES branch to Step 212. In Step 212, the DQR Application 100 adds the name of the selected field to the Details Drop Box Area 143, and continues to Step 205 to display the fields and relations associated with the selected view.

In Step 209, the DQR Application 100 monitors group field selections. If a user selects a group field, the DQR Application 100 proceeds through the YES branch to Step 213. If a user does not select a group field, the DQR Application 100 continues through the NO branch to step 210.

In Step 210, the DQR Application 100 monitors measure field selections. If a user selects a measure field, the DQR Application 100 proceeds through the YES branch to Step 214. If a user does not select a measure field, the DQR Application 100 continues through the NO branch to Step 211.

In Step 211, the DQR Application 100 monitors the selection of relations. If a user selects a relation, the DQR Application 100 proceeds through the YES branch to Step 215. If a user does not select a relation, the DQR Application 100 continues through the NO branch to Step 205.

In Step 215, if the cardinality of the relation path ending with the selected relation is to-one, the DQR Application 100 follows the NO branch of Step 215 to Step 216. In Step 216, the DQR Application 100 retrieves the fields and relations associated with the followed relation and processing passes to Step 205. If the cardinality is to-many, the YES branch of Step 215 is followed to Step 217 where the DQR Application 100 limits retrieval of the fields associated with destination view to those fields that have a Field Type Property F07 (see FIG. 3D) set to “aggregate” and then processing is passed to Step 205. In this manner, the cardinality of the destination view relative to the base view constrains field selection. If the cardinality is to-many, only aggregated values associated with the destination view may be returned, thereby ensuring that each row returned by the DQR Application 100 represents exactly one row in the base view selected for the report.

In Step 218, if at least one field has been added to the report, the YES branch is followed to Step 220, where the DQR Application 100 verifies and generates a suitable database query and displays the report on the Display Device 19. In Step 221, if the Fields Button 134 is selected, the YES branch is followed to step 205. Otherwise the process terminates.

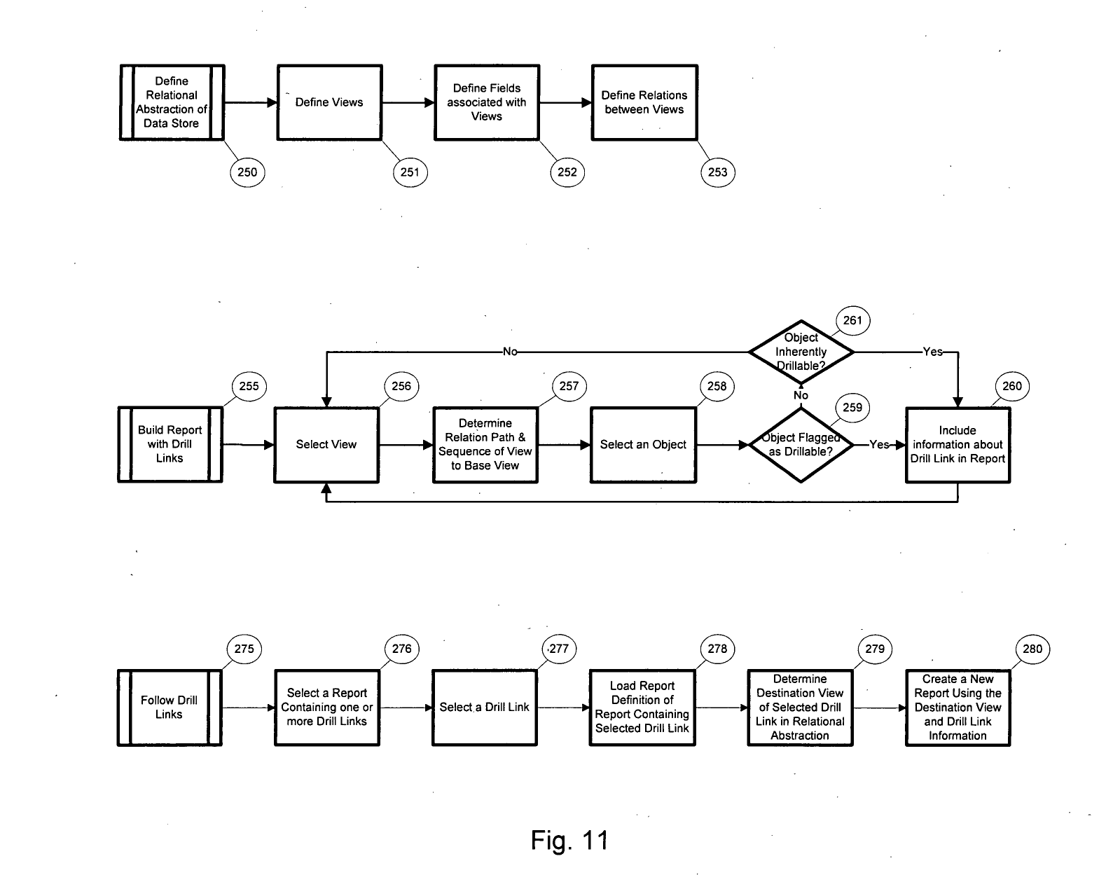

FIG. 11 displays a flowchart that details the steps of operation of creating drill links in a report and following drill links in a report according the invention.

Steps 250 through 253 display the steps of defining a relational abstraction of a data store. In step 251, views of the relational abstraction are defined. View definitions typically include the objects described in Table 51 of FIG. 3D. Note in the view definition of the Customer View 40 (see FIG. 3A) of the Northwind example used herein that the following default fields are included:

```
<object xsi:type=“view name=“Customer” >
  <primaryKey keyColumn=“CustomerID” dataType=“text” />
  <defaultFields>
    <field ref=“m:/Northwind/Customer/Company Name” />
    <field ref=“m:/Northwind/Customer/Contact Name” />
    <field ref=“m:/Northwind/Customer/Postal Code” />
  </defaultFields>
  </object>
```

These default fields are used in an embodiment of the invention, together with the relational abstraction definitions for other objects to provide a default drill template report when elements of Customer view 40 are included in a report.

In step 252, fields of the relational abstraction are defined according to certain object properties such as those described in Table 52 of FIG. 3D. Referring to Table 52, the allowDrill Object Property F06 flags whether a drill link associated with the field should be included in a report. In addition, a field definition that has the Field Type Object Property F07 set to aggregate are, according to an embodiment of the invention, always assumed to be drillable.

In step 253, relations of the relational abstraction are defined according to the detailed discussion provided above for FIG. 3E.

Steps 255 through 261 display the steps of generating a report that includes drill links. In step 256, a view is selected. The selected view could be any view defined in the relational abstraction. In step 257, the relationship between the selected view and the base view of the report is determined. According to an embodiment, the relationship is maintained as part of a relation path. The relation path maintains all relations traversed in building a report, and includes the sequence of relations followed. Although typically selecting a view occurs through user-program interaction through a display device, one skilled in the art will recognize that any means of selecting a view might be used according to the invention.

In step 258, objects associated with the view are selected or relations associated with the view are followed. As objects are selected, a decision is made whether to build a drill link for each selected object. In step 259, if the object definition contained in the relational abstraction is flagged as drillable, processing proceeds to step 260 where information about the drill link is included in the report. Alternatively, the selected object may be flagged at runtime as drillable by a user. If a selected object is not flagged as drillable in the relational abstraction or by user input, processing proceeds to step 261 where the object type of the selected object is determined. If the object type is inherently drillable, such as an aggregate field, processing proceeds to step 260. Otherwise, a drill link is not included for the selected object and processing returns to step 256.

Steps 275 through 281 display the steps of following drill links in a report. A drill link is processed starting at step 276. In step 276, a report containing a drill link is selected. This selection will typically be made through displaying a report name on a display device and selecting the report using keyboard or mouse interaction. However, one skilled in the art will recognize that any means of selecting a report containing a drill link may be used according to the invention. In step 277, a drill link contained in the report is selected. Again, one skilled in the art will recognize that any means of selecting a drill link may be used according to the invention. In response to selecting a drill link, the report definition containing the drill link is loaded.

In step 279, processing continues where the relation path associated with the view of the selected object, or destination view, is determined. The relation path will contain a sequence of one or more relations from the base view that was selected when the originating report was created. The relation path sequence may be empty if the destination view is the same as the base view.

In step 280, a new report is created using the destination view and the drill link information. According to the invention, a new report is created, meaning that the destination view becomes the base view for the new report. The new base view and the drill link information are combined to create the new report, the new report containing objects defined in the relational abstraction for the base view. Typically, the new report is also filtered using the filters applied to the originating report and the object underlying the drill link.

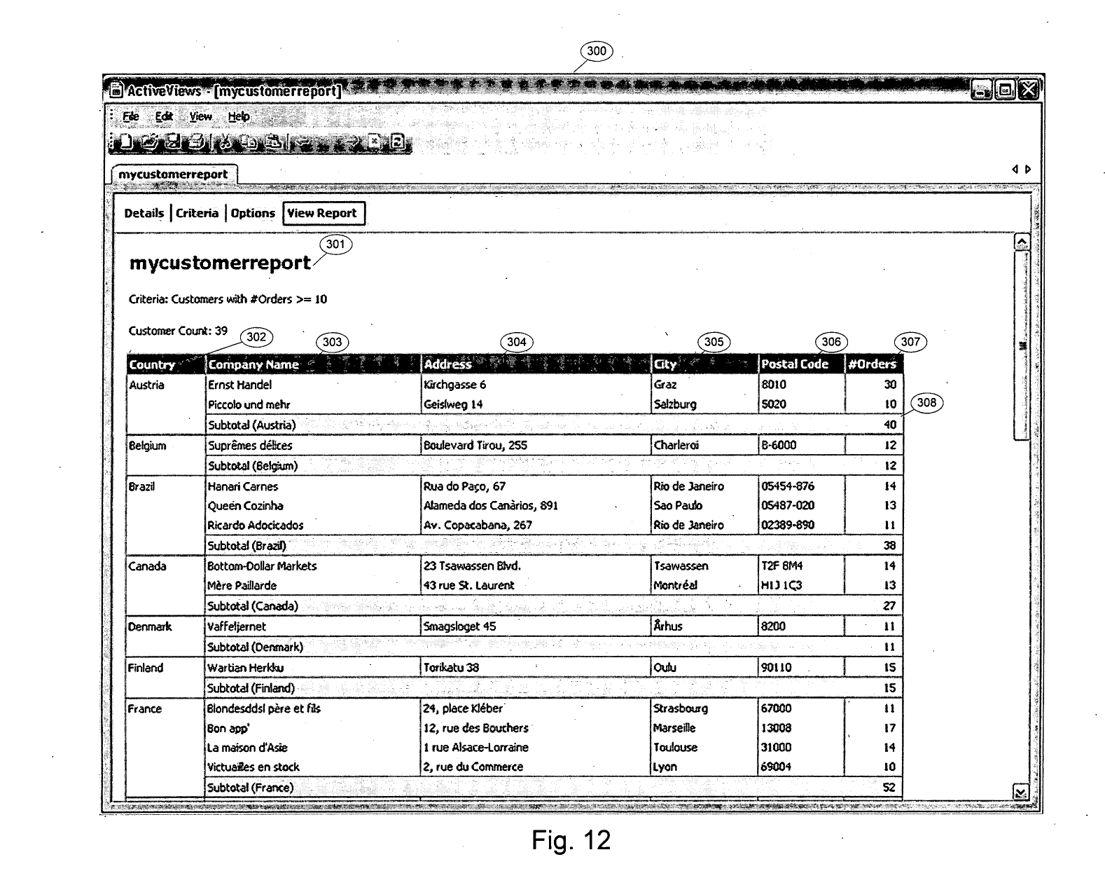

FIG. 12 depicts the Display Window 300 of an embodiment of the DQR Application 100 that illustrates the Mycustomerreport Report 301, a report containing drill links according to the invention. The Mycustomerreport Report 301 is a customer report based upon the Northwind sample database. The Mycustomerreport Report 301 is grouped by country, as illustrated by the Customer Grouping 302, and displays the customer name, address, city and postal code, and the number of orders for all customers with ten or more orders, as illustrated by the Company Name Column Heading 303, the Address Column Heading 304, the City Column Heading 305, the Postal Code Column Heading 306 and the #Orders Column Heading 307.

The rows below the #Orders Column Heading 307 are based upon the Orders Field 53 depicted in the Orders View 47 of FIG. 3B and, according to the definition of Orders View 47, include data from the orders table of the Northwind sample database. Because the Orders Field 53 is an aggregate type field, a drill link is included in the Mycustomerreport Report 301. For example, the Austria Subtotal #Orders 308 depicts that there are 40 customer orders from Austria for customers who had ten or more orders.

As discussed above, the Mycustomerreport Report 301 includes five columns, which represent fields in the Northwind database. Of the five fields, two of them, the company name field, as identified under the Company Name Heading 303, and the postal code field, as identified under the Postal Code Heading 306, have Field Object Property F06 of Table 52 (see FIG. 3D) set to “true” and thus drill links are included in the Mycustomerreport Report 301 for these fields. In addition, because the orders field, as identified under the #Orders Heading 307 has the Field Type Object Property F07 of Table 52 set to “aggregate,” a drill link is also included for this field. The Count of Orders Drill Link 308 is also included because it is a count of orders and therefore inherently drillable.

In the present embodiment, the information contained in the report definition for the Mycustomerreport Report 301 for the Count of Orders Drill Link 308 is as follows:

```
<Action>
      <Hyperlink>=IIf(Parameters!DrillLinks.Value =
      Boolean.TrueString, Code.Drill.CreateLink(Globals, “6”,
      new String( ) {“f8_k0”}, new Object( ) {Fields!Country2_{—}
      k0.Value}, new Boolean( ) {False}),
      Nothing)</Hyperlink>
</Action>
```

The link information describes if the link can be drilled, identifies the ID of the order count field and includes grouping keys for customers and country. According to the invention, a drill link may contain various pieces of information that may be useful in generating a report.

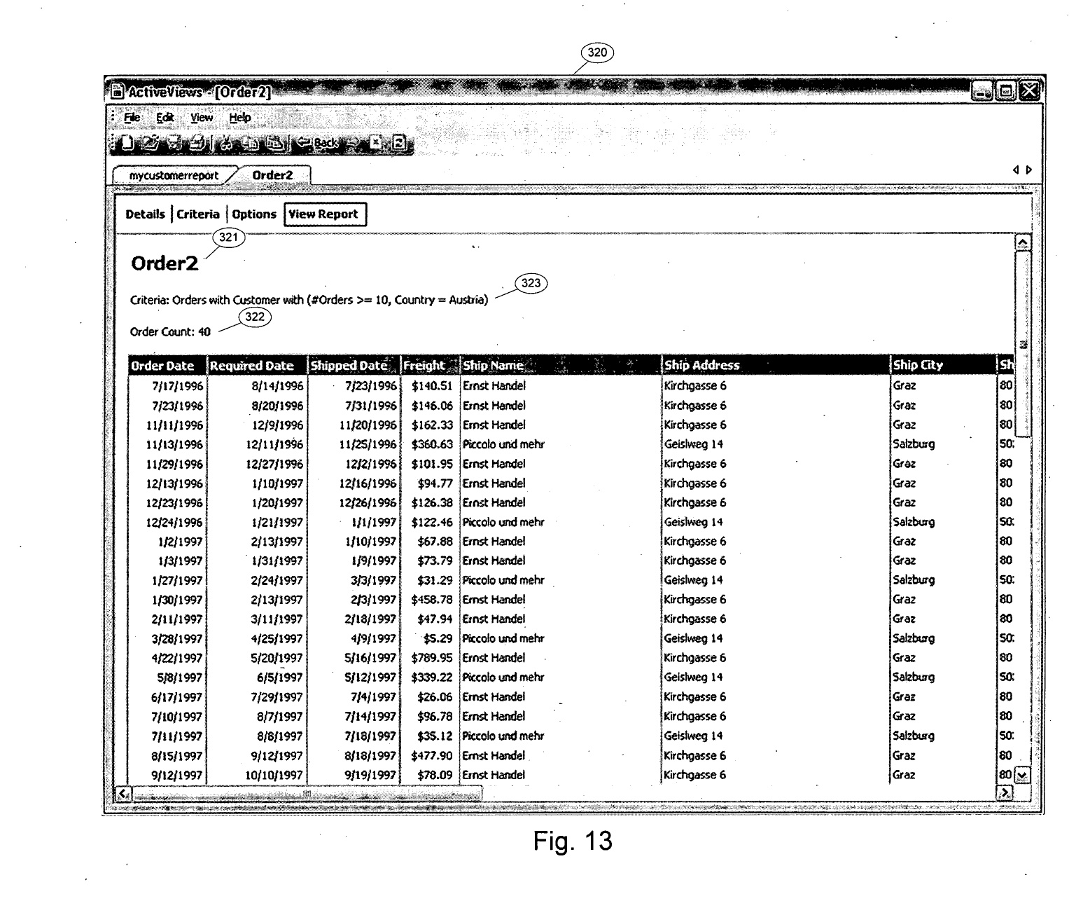

FIG. 13 depicts the Display Window 320 of an embodiment of the DQR Application 100 that illustrates the Order2 Report 321. The Order2 Report 321 provides results from the DQR Application 100 extracting the information contained in the Count of Orders Drill Link 308 of FIG. 12 and generating a new report. The Text Field 322 illustrates that the DQR Application 100 has returned the same number of records as indicated in the Count of Orders Drill Link 308. The Criteria Text Field 32 indicates that the Order2 Report 321 was generated using the filters of the Mycustomerreport Report 301 and the selected Count of Orders Drill Link 308 for Austria. As earlier described, the columns of the Order2 Report 321 result from the destination view of the count of orders field.

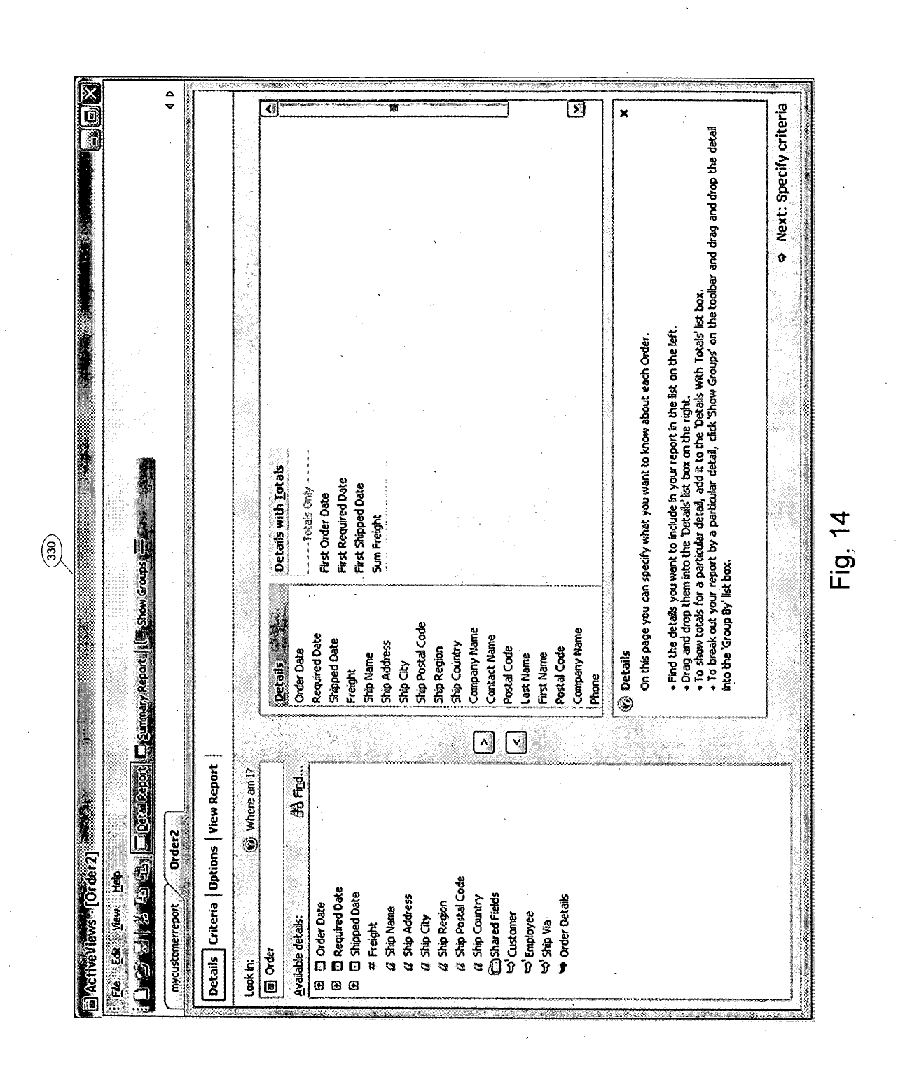

FIG. 14 depicts the Display Window 330 of an embodiment of the DQR Application 100 that illustrates the fields automatically included in the Order2 Report 321.

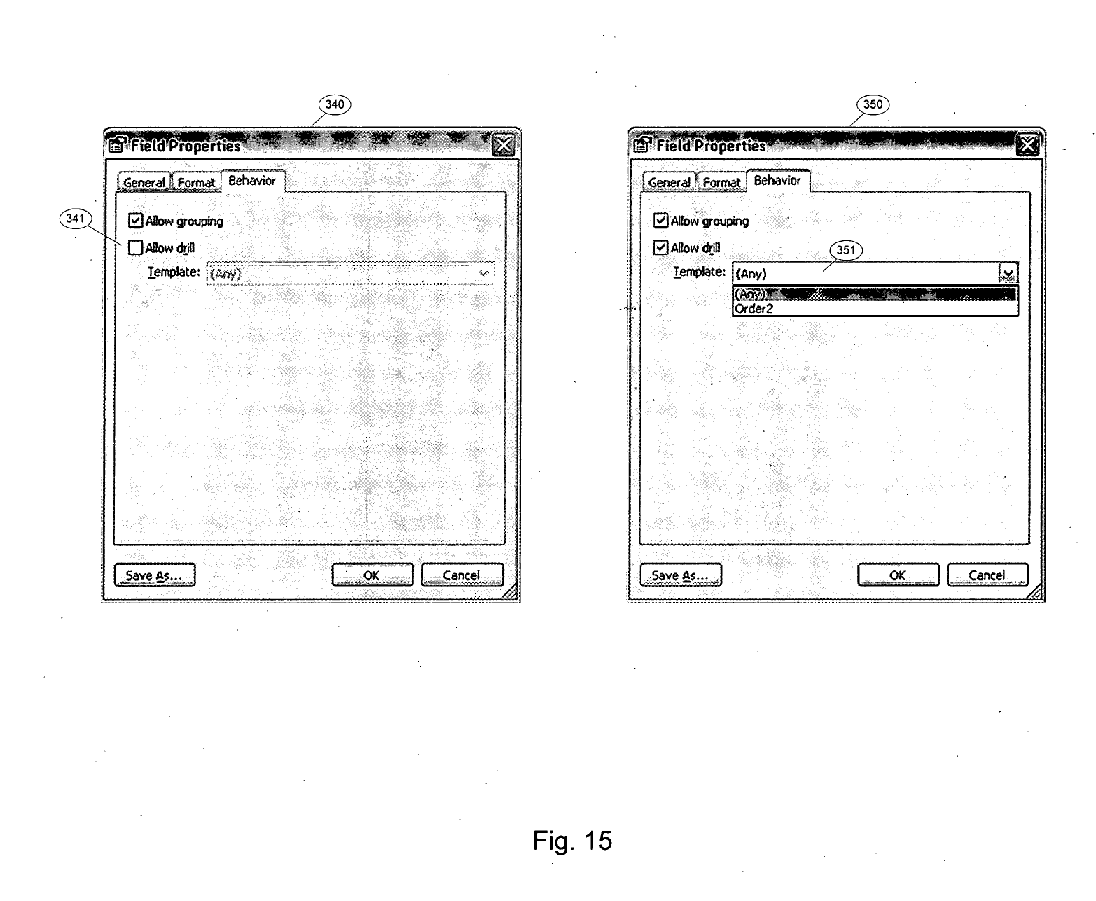

FIG. 15 depicts the Display Window 340 and the Display Window 350 of an embodiment of the DQR Application 100 that illustrates how users may change whether a field is drillable. According to the following field definition of the Ship City 49 of the Orders View 47 (see FIG. 3B), the Ship City 49 field is not drillable, since it does not include the Field Ojbect Property allowDrill F06 of Table 52 (see FIG. 3D):

```
<object xsi:type=“savedSourceField” parentObjectID=
“m:/Northwind/Order” name=“Ship City” viewID=“m:/Northwind/Order”
sourceColumn=“ShipCity” dataType=“text”>
  <field allowEmpty=“true” alignment=“general” valueWidth=“14”
  allowAsGroupField=“true” />
</object>
```

However, the Allow Drill Checkbox 341 of FIG. 15 depicts how a user may override the Field Ojbect Property allowDrill F06 of Table 52 of the Ship City 49 for a report. Further, the Drill Template Drop Down Box 351 depicts how a user might select a different drill template to be applied to the Order2 Report 321.

It will be obvious to those of skill in the art that the invention described in this specification and depicted in the FIGURES may be modified to produce different embodiments of the present invention. Thus, the present invention has several advantages over the prior art without sacrificing any of the advantages of the prior art. Although two embodiments of the invention have been illustrated and described, various modifications and changes may be made by those skilled in the art without departing from the spirit and scope of the invention.

1. A method for creating drill links in a report, comprising the steps of:
a) defining a relational abstraction of a data store, the definition including a plurality of views, scalar or aggregate fields associated with the views, and relations between the views; and
b) generating a report that includes at least one drill link associated with a sequence of zero or more relations originating at a base view of the relational abstraction.

2. A method of claim 1 wherein the report is in a well recognized format.

3. A method of claim 2 wherein the report format is HyperText Markup Language (HTML).

4. A method of claim 2 wherein the report format is Dynamic HyperText Markup Language (DHTML).

5. A method of claim 2 wherein the report format is eXtensible Markup Language (XML).

6. A method of claim 2 wherein the report format is Portable Document Format (PDF).

7. A method of claim 2 wherein the report format is Scalable Vector Graphics (SVG).

8. A method of claim 1 wherein the drill link includes additional information.

9. A method of claim 8 wherein the drill link includes a reference to a second report.

10. A method of claim 8 wherein the drill link includes a reference to an object not associated with the relational abstraction.

11. A method of claim 10 wherein the drill link includes a reference to a computer program.

12. A method of claim 8 wherein the drill link includes a reference to the report that includes the drill link.

13. A method of claim 8 wherein the drill link includes a reference to the context of the drill link within the report.

14. A method of claim 8 wherein the drill link includes key values identifying a particular value within the report.

15. A method of claim 1 wherein the drill link is additionally associated with an object of the relational abstraction whose base view is the destination view of the last relation in the sequence.

16. A method of claim 15 wherein the object is a scalar field.

17. A method of claim 15 wherein the object is an aggregate field.

18. A method of claim 1 wherein the drill link includes a reference to an object that is based upon at least one object of the relational abstraction whose base view is the destination view of the last relation in the sequence.

19. A method of claim 18 wherein the reference is to a report template.

20. A method of claim 18 wherein the reference is to an expression.

21. A method for following drill links in a report, comprising the steps of:
a) defining a relational abstraction of a data store, the definition including a plurality of views, scalar or aggregate fields associated with the views, and relations between the views;
b) displaying a first report containing at least one drill link associated with a sequence of zero or more relations originating at a base view of the relational abstraction;
c) upon selection of the drill link, extracting information associated with the drill link; and
d) generating a second report using the extracted information.

22. A method of claim 21 wherein the extracted information includes a reference to a scalar field.

23. A method of 21 wherein the extracted information includes a reference to an aggregate field.

24. A method of 21 wherein the extracted information includes a reference to an expression.

25. A method of 21 wherein the extracted information includes a reference to a report template.

26. A method of 21 wherein the extracted information includes a reference to another report.

27. A method of claim 25 wherein a plurality of templates are displayed for user selection.

28. A method of 21 wherein extracted information includes a reference to a relation.

29. A method of claim 21 wherein the extracted information includes a reference to the first report.

30. A method of claim 21 wherein the extracted information includes a reference to a dynamic web page for the second report.

31. A method of claim 21 wherein the extracted information includes a reference to the context of the drill link within the first report.

32. A method of claim 21 wherein the extracted information includes a reference to grouping key values identifying a particular value within the report.

33. A method of claim 21 wherein the extracted information is used to apply a filter on the second report.

34. A computer system for creating drill links in a report, the system comprising:
a) means for defining a relational abstraction of a data store, the definition including a plurality of views, scalar or aggregate fields associated with the views, and relations between the views; and
b) means for generating a report that includes at least one drill link associated with a sequence of zero or more relations originating at a base view of the relational abstraction.

35. A computer system for following drill links in a report, the system comprising:
a) means for defining a relational abstraction of a data store, the definition including a plurality of views, scalar or aggregate fields associated with the views, and relations between the views;
b) means for displaying a first report containing at least one drill link associated with a sequence of zero or more relations originating at a base view of the relational abstraction;
c) upon selection of the drill link, means for extracting the information associated with the drill link; and
d) means for generating a second report using the extracted information.
